(19) United States
(12) Patent Application Publication
(10) Pub. No.: US 2026/0289026 A1
(43) Pub. Date: Sep. 24, 2026

(54) A SYSTEM AND METHOD FOR MANUFACTURING CUSTOM-FITTED FOOTWEAR AND OTHER ARTICLES

(71) Applicant: Vivo Barefoot Limited, London (GB)

(72) Inventor: Peter Davis, London (GB)

(21) Appl. No.: 19/476,099

(22) PCT Filed: Jun. 10, 2024
(86) PCT No.: PCT/GB2024/051487

§ 371 Date: Oct. 16, 2025

(30) Foreign Application Priority Data
Jun. 9, 2023 (GB) 2308681.2

(51) Int. Cl. G06F 30/10; A43D 3/02

(52) U.S. Cl. CPC G06F 30/10; A43D 3/02; A43D 2200/60

(57) ABSTRACT

A method (200) of creating a three-dimensional, 3D, digital last of an appendage representing a part of a human body for use in manufacturing a custom-fitted wearable article is described. The method comprises: receiving a 3D mesh object representing the appendage, the mesh object comprising a plurality of vertices and edges that defines the shape and size of the appendage; orienting the mesh object in a plurality of degrees of freedom to align the mesh object with a predetermined orientation (202); determining, from the mesh object, the values of each of a set of predetermined landscaped points specific to the type of appendage, each predetermined landscape point being configured to represent a particular geometric position of the appendage and being defined with respect to a predetermined reference point in the mesh object when orientated in the predetermined orientation (206, 208, 210); creating a set of parameters to represent the mesh object, each parameter being defined as a predetermined measurement between at least two different landscape points; and storing the set of parameters as the 3D digital last of the appendage.

### TECHNICAL FIELD

The present invention relates to methods of designing and manufacturing custom-fitted footwear and other wearable articles, which are designed to fit to a part of a human body. More particularly, though not exclusively, the present invention relates to improved methods for creating custom lasts of such wearable articles, such as footwear, headwear and gloves, and more efficient design and manufacturing processes for creating such bespoke wearable articles, from the custom lasts.

### BACKGROUND

Whilst this disclosure is related to the design and manufacture of all different types of wearable articles, the present description focusses on footwear, though it is to be appreciated that the present disclosure is not restricted as such.

In the field of footwear manufacturing, to create an article of footwear, a model of a human foot known as a ‘last’ is used. Traditionally, lasts were physical models on which shoes were constructed, but technology now allows for lasts to be digital models, and footwear is built around the last by designers using computer-aided design (CAD) software. A last defines the shape and size of a foot and is the mould on which a shoe is built. The last therefore determines the shape, size, and fit of the footwear created. Lasts are standardised around different sizes, with differently sized lasts available to design and manufacture footwear to fit different sizes of feet. However, due to the size standardisation, where the number of different sizes is necessarily limited, a last is always an approximate size, and not an exact fit to the foot of most individuals.

Recently, custom-fitted footwear has been increasing in popularity because this type of footwear offers various advantages such as increased comfort, support, and performance. To create a custom-fitted shoe, a custom last that exactly models a user's foot is required. Recent technology has enabled the creation of such bespoke digital lasts from a scan of a foot: individual dimensions corresponding to measurements required for a last are obtained from the scan and these measurements are used to build a custom digital last. The footwear is specified by designers using CAD software (a manual process) to fit the last and create a digital model (as a CAD file) of the custom shoe. The CAD file is then provided to manufacturers who use the CAD file to design and manufacture the appropriate manufacturing tools (such as moulds and stamps), and the shoe is produced, based on the CAD file, using the custom manufacturing tools. There are, however, currently limitations in the methods used to create the digital last and the custom-fitted shoes that relate to the accuracy, efficiency, and consistency of the various processes involved.

Creating a custom-fitted shoe involves first creating a custom last from a scan of a user's foot. An existing method 10 used to create the custom last is illustrated in the flowchart in FIG. 1. The prior art method starts with a foot scan being captured and then fitted into a bounding box (B-box), which is used to define the length and width variables of the scanned foot. Using the length and width measurements defined by the B-box, the representation of the foot is divided into percentages based on Y-axis length to obtain a series of points which define the geometry of the foot. However, the points are often inaccurate, so are subsequently manually adjusted to better match the foot scan. Once the points have been manually adjusted (using CAD), and suitably define the foot geometry, they are used to obtain the measurements required for the physical last. These measurements are used to build the geometry and create the custom last. FIG. 2 shows three examples of digital lasts created using the above method. The same last is shown modelled using different mesh techniques namely a nurbs surface, a tri/quad mesh, and a sub d mesh, but any type of mesh can be used.

There are several disadvantages associated with this method of creating a custom last. Firstly, the last measurements are significantly impacted by any rotation that may be present in the input foot scan. Rotation of the scan significantly affects the size and shape of the B-box, and thus affects the measurements of the length and width of the foot. FIGS. 3A and 3B show a comparative example of the impact of a scan being rotated 2 degrees in the X-Y plane. As illustrated, FIG. 3A shows a first digital last 20 and a first scan of a foot 22 and FIG. 3B shows the same digital last 20 and a scan of the same foot 22 rotated by 2 degrees on the X-Y plane. As can be seen from these figures, a scan rotation of 2 degrees changes the length and width of the B-Boxes significantly, which leads to inaccurate foot length and width dimensions being derived. As these dimensions are used to locate the series of points that characterise the foot geometry, and so ultimately define the last measurements, inaccurate foot lengths and widths lead to an inaccurate last. If the scan is rotated in all 6 degrees of freedom, for example if a scan is tilted due to the user's heel lifting when the scan is carried out, the impact is even greater.

Manual orientation is also required to fit a foot scan to a B-box, and so this is another cause of the length and width of the foot (defined by the B-box) being inconsistent. If these dimensions are inconsistent, the percentage lengths and thus the series of points that are derived from the B-box are often not perfectly matched to the foot. This is shown in FIG. 4A, where the initial approximated points derived from the B-box are shown as not exactly matching the foot geometry. As described above, each point must be manually adjusted which is time-consuming and prone to human error. The resultant last measurements (for example, the dashed lines in FIG. 4A) are therefore often approximations, and not accurate. This is illustrated in FIG. 4B, which shows two foot scans 30, 32 and their associated dimensions, and the corresponding lasts 34, 36 where the dimensions were obtained from fitting the scans to bounding boxes and manually adjusting the points. Inaccurate last measurements are also shown in FIG. 4C, where in each instance, the top number represents the dimension of the foot from the scan, and the bottom number represents the last dimension generated using the prior art methods discussed above. As shown in FIGS. 4B and 4C, the last dimensions are different to the actual dimensions of the foot, and thus the last is inaccurate.

Another drawback of this prior art method is that only a single view of the scan is used when manually adjusting the points, and so not every direction is taken into consideration. This also leads to inaccurate calculation of geometry of the scanned foot.

Finally, this method of creating lasts is last-orientated, where the particular measurements obtained from the foot scan are typically based on the specific parameter measurements (limited in number) required for creating lasts, and do not take into consideration the dimensions of the entire foot.

For these reasons, current methods of creating lasts are time-consuming, laborious, and prone to error, leading to inconsistent lasts that do not accurately model a user's foot.

Once the custom digital last is created, a modelling process is used to build structure and texture around the custom last, and thus create the custom footwear. In existing methods, UV mapping is the modelling process that is often used and is a technique where a three-dimensional (3D) model's surface is unwrapped to create a two-dimensional (2D) image (in U and V orthogonal coordinates). Textures are applied to the 2D image and, once rendered, the features can be projected back to the 3D model (i.e. the digital last). An example of this process is illustrated in FIGS. 5A and 5B. FIG. 5A shows a 3D polygon model, and FIG. 5B shows the same model split into component parts and unwrapped to 2D. When this process is used to create footwear, the footwear is created around the last, and will perfectly fit the foot on which the last was modelled.

This method 40 of UV mapping is outlined in more detail in the flowchart in FIG. 6. Firstly, a UV map is created on a 3D mesh object such as a digital last, and co-ordinates are generated for each vertex on the mesh. For complex objects such as a foot, the object is split into different sections, and for each section a seam is selected at the location where the 3D UV map should be cut. The section is cut at the selected seam and unrolled to create a 2D UV map of that section, where each vertex has orthogonal U, V and W coordinates. By splitting the object into a plurality of smaller sections, the amount of distortion when that portion of the object is unfurled into a 2D-representation is reduced. However, such a process still generates distortions at the seams, so these are manually adjusted to obtain uniform UV vectors at either side of the seam. Substance can then be added to the 2D UV map, and anything created is projected back onto the 3D UV map through the corresponding co-ordinate systems to create substance in 3D space. This happens for each section of the object, and the result is a custom-shoe that fits the custom-last.

There are significant drawbacks associated with this UV mapping technique. Firstly, sectioning the foot scan into separate parts for unwrapping increases the complexity of the process. In addition, the requirement of ensuring consistency at the seams and edges of each part is a manual process which requires human interaction with software, making this process extremely time-consuming. This adjustment must be carried out for each separate part of the foot scan, otherwise when the multiple components are combined, post deformation, the seams and edges will not match.

There are also disadvantages associated with needing to first design the shoe in a 2D design environment and then projecting this back into a 3D space. With this technique, a new custom 2D map is required for each custom last, and so the footwear must be redesigned from scratch each time. Accordingly, using this technique results in a highly inefficient design process requiring time-consuming human involvement.

Custom shoes are then produced from the 3D CAD models of the shoes. Traditionally, the 3D file (3D model or 3D digital last) is provided to a manufacturer, who first converts the 3D file into appropriate tooling such as moulds and stamps, that are specifically made to manufacture the custom shoe. The traditional method 50 for creating footwear from such 3D models is depicted in the flowchart of FIG. 7. The upper is dressed at Step 52, using the tools designed from the 3D CAD file of the shoe. The dressed last is then assembled dry with sole components at Step 54. Then, at Step 55, the region where the sole components will be attached is marked, before glue attachments are manually painted on at Step 56. The shoe glue is left to dry disassembled at Step 57, and then the soles and the upper glues are reactivated (usually with heat) and are pressed together at Step 58. Finally, at Step 59, the completed shoe is placed in a chiller to cure all glue completely.

There are several inefficiencies in the method described above. Firstly, manufacture of tooling elements, such as moulds and stamps, is a prolonged process where several iterations (following feedback from designers) are required before arriving at tools that are suitable for creating the shoe. The tooling elements must also be customised for each size and design of shoe, which is extremely inefficient, and creates a bottleneck in mass production of custom shoes. There is also a disconnect between shoe design and creation of the tooling, which again elongates the manufacturing process.

Creating footwear also requires the generation of toolpaths for robots (robot arms) to traverse when assembling each shoe. Toolpaths must be defined in the 3D digital model of the shoe and are used to guide robot arms during manufacture of the shoe. For example, toolpaths guide a robot arm to deposit glue at certain locations for fixing the sole to the upper. In existing methods 60 as illustrated in FIG. 8, generating toolpaths is a post-process of the design stage: the foot scan is input to the software, a 3D model of the custom footwear is created using CAD, and then toolpaths are added manually in CAD software or in code.

This method has several disadvantages. Firstly, it is a manual process, which requires human interaction with software programs to define the toolpaths. The process can therefore be prone to human error. Also, because this industry process is not standardised, finding technicians with the required knowledge of programming to code instructions determining the specific movement of the robot (robot arm) being used is challenging, which in turn can lead to a bottleneck in the shoe manufacturing process. For example, such a technician would not only have to program correct gluing locations on the upper for each custom shoe design, but also, where multiple layers are combined in shoe manufacture, maintain the uniformity of toolpaths to minimise toolpath intersections and possible collision with external objects in the build volume of the robot arm. Adding toolpaths at the post-processing stage is also extremely time-consuming and inefficient when creating custom objects such as custom footwear, as toolpaths need to be regenerated for each custom object. This exacerbates the bottleneck and slows the process of mass-producing shoes.

An objective of the present invention is therefore to address at least some of the limitations outlined above relating to at least one of the different areas described: custom last creation, UV mapping, custom shoe design and manufacture, and generation of toolpaths. In particular, it is desired to create more accurate, efficient, and consistent processes for generating custom-fitted wearable articles such as footwear.

### SUMMARY OF THE INVENTION

According to one aspect of the present invention there is provided a method of creating a three-dimensional (3D) digital last of an appendage representing a part of a human body for use in manufacturing a custom-fitted wearable article, the method comprising: receiving a 3D mesh object representing the appendage, the mesh object comprising a plurality of vertices and edges that defines the shape and size of the appendage; orienting the mesh object in a plurality of degrees of freedom to align the mesh object with a predetermined orientation; determining, from the mesh object, the values of each of a set of predetermined landscaped points specific to the type of appendage, each predetermined landscape point being configured to represent a particular geometric position of the appendage and being defined with respect to a predetermined reference point in the mesh object when orientated in the predetermined orientation; creating a set of parameters to represent the mesh object, each parameter being defined as a predetermined measurement between at least two different landscape points; and storing the set of parameters as the 3D digital last of the appendage.

The orientation step may comprise aligning the mesh object with a major axis of the appendage, the major axis comprising the longest axis of the appendage.

The orientation step may comprise pitch/roll aligning of the mesh object with an X-Y plane. The pitch/roll aligning step may comprise: determining the major axis of the mesh object by creating a bounding bubble sphere around the mesh object; reducing the size of the bounding bubble sphere by a predetermined percentage; identifying any points of the mesh object which are outside the reduced size bounding bubble sphere; and using the identified points to determine the major axis of the appendage between the identified points.

In some embodiments the pitch/roll aligning step further comprises: creating a plane along the major axis of the appendage; creating a 2-dimensional (2D) profile of the appendage using the intersection of the plane and the mesh object; determining specific features of the appendage by measuring distances from vertices of a bounding box around the 2D profile to the closest point in the 2D profile, the determining step including determining an anchor point of the appendage; and using the anchor point to specify and appendage area which should be aligned with an X-Y plane; and aligning the mesh object with an X-Y plane comprising the anchor point.

The orientation step may comprise yaw aligning of the mesh object within an X-Y plane, with the Y axis. In some embodiments the yaw aligning step comprises: defining the anchor point as an origin point of rotation; translating each of the mesh object points and the centroid of the appendage from 3D locations in the mesh object to 2D locations into the X-Y plane; carrying out geometric calculations using the anchor point and main axis to define the centre of the appendage; and aligning a vector from the anchor point the centre of the appendage with the Y axis so as to align the mesh object with the Y-axis.

The orientation step may comprise using a plurality of different bounding algorithms to determine orientation of the mesh object and then selecting the most accurate algorithm to provide the determined orientation. The plurality of bounding algorithms may be selected from the group of bounding algorithms comprising Euclidean, Welzl, Bouncing Bubble, and minimal Bounding-Box algorithms.

The receiving step further comprises receiving a User Identifier (ID) with the mesh object and the storing step comprises storing the User ID with the 3D digital last of the appendage.

In some embodiments, the storing step comprises creating an anonymised data file comprising the set of landscaped points, the position of the landscaped points in 3D space, and the set of parameters, and storing the same in the data store.

In some embodiment the method further comprises using a plurality of the anonymised data files to create an averaged 3D digital last by averaging data of the anonymised data files.

Preferably, the using step comprises filtering the anonymised data files to select a subset with specific predetermined characteristics to determine a specific digital last conforming to those characteristics.

The method may further comprise obtaining the 3D digital last and the averaged 3D digital last, calculating the difference between the landscaped points of the averaged 3D digital last and the landscaped points on the 3D digital last, using the difference to calculate a vector and morphing the averaged last to a new adjusted 3D digital last using the vector.

In some embodiments, the method further comprises scanning an appendage and creating a 3D mesh object representing the appendage.

Preferably, the 3D mesh object represents a human foot or hand.

According to another aspect of the present invention there is provided a system for creating a three-dimensional (3D) digital last of an appendage representing a part of a human body for use in manufacturing a custom-fitted wearable article, the system comprising: an input processor configured to receive a three-dimensional mesh object representing the appendage, the mesh object comprising a plurality of vertices and edges that defines the shape and size of the appendage; an object orientation engine configured to orient the mesh object in a plurality of degrees of freedom to align the mesh object with a predetermined orientation; an object landscaper configured to determining, from the mesh object, the values of each of a set of predetermined landscaped points specific to the type of appendage, each predetermined landscape point being configured to represent a particular geometric position of the appendage and being defined with respect to a predetermined reference point in the mesh object when orientated in the predetermined orientation; a data extractor configured to create a set of parameters to represent the mesh object, each parameter being defined as a predetermined measurement between at least two different landscape points; and a data store configured to storing the set of parameters as the 3D digital last of the appendage.

According to another aspect, there is provided a method of creating a three-dimensional (3D) wearable article model for use in manufacturing a custom-fitted wearable article, the method comprising: receiving a 3D digital last of an appendage representing a part of a human body, the 3D digital last comprising a plurality of vertices defining the shape and size of the appendage and having a central point and a main axis; providing a mesh cylinder within the 3D digital last, the mesh cylinder comprising a plurality of control points; aligning a centre of the mesh cylinder with the central point and orienting the mesh cylinder along the main axis; generating opposing fixed anchor seams at respective opposing ends of the 3D digital last, each fixed anchor seam having a fixed location; stretching opposing ends of the mesh cylinder to the respective fixed anchor seams; creating a soft anchor within the 3D digital last, the soft anchor defining a set of vertices having a limited ability to move and being operative on a circumference of points located between the opposing ends of the mesh cylinder; iteratively warping the cylinder mesh to minimise the tension between the opposing anchor seams and the soft anchor until the cylinder mesh and the 3D digital last converge; and outputting the warped cylinder mesh as the 3D wearable article model.

The step of generating the fixed anchor seams may comprise: determining normals of all mesh faces of the 3D digital last, and culling the points in the 3D digital last based on the normals' angle to a Z-axis, wherein each normal is a vector in a normal direction to the mesh face; determining the edges of the unculled mesh faces of the 3D digital last; and assigning the determined edges to the opposing fixed anchor seams.

The step of stretching the ends of the mesh cylinder may comprise: dividing each fixed anchor seam by the number of end control points located at the circumference of the closest end of the mesh cylinder to the fixed anchor seam; calculating the vectors between the end control points at each end of the mesh cylinder to the closest fixed anchor seam; and using the vectors to move the end control points to the closest fixed anchor seam.

Each of the plurality of control points may comprise a weight, the weight determining the amount of allowable movement of the associated control point, and wherein the step of iteratively warping the cylinder mesh comprises moving each of the plurality of control points in accordance with its weighting.

In some embodiments, the fixed anchor seams have a high weight preventing movement, the soft anchor having a medium weight permitting limited movement and the remaining control points of the mesh cylinder have a low weighting enabling maximum movement.

The method may further comprise generating parameters controlling the manner in which the cylinder mesh is iteratively warped. In some embodiments, the step of generating parameters comprises generating a pull parameter, the pull parameter determining a vector for each of the control points of the mesh cylinder towards a closest one of the plurality of vertices of the 3D digital last. Alternatively or in addition, the step of generating parameters may comprise generating a vector tension parameter, the vector tension parameter determining a vector tension between the control points of the mesh cylinder required to pull all control points together to ensure the cylindrical mesh maintains its structure. Alternatively or in addition, the step of generating parameters may comprise generating a spherical parameter, the spherical parameter comprising an average vector for a particular control point determined from the values of the vectors of the closest neighbouring control points to the particular control point.

In some embodiments the step of iteratively warping the cylinder mesh comprises generating the pull parameter, the vector tension parameter and the spherical parameter in parallel.

The step of iteratively warping the cylinder mesh may comprises recalculating the parameters after each iteration.

The step of iteratively warping the cylinder mesh may comprise setting a convergence threshold and stopping the iteratively warping step once the convergence threshold has been reached. Alternatively, the step of iteratively warping the cylinder mesh may comprise determining a predetermined number of iterations and stopping the iteratively warping step once the number of iterations has been reached.

Preferably, the 3D wearable article model comprises a model of a shoe or glove.

The present invention also extends to a method of creating a 3D wearable article model for use in manufacturing a custom-fitted wearable article, the method comprising: a method of creating a three-dimensional (3D) digital last as described above and a method of creating a 3D wearable article model for use in manufacturing a custom-fitted wearable article as described above.

According to another aspect of the present invention there is provided a system for creating a 3D wearable article model for use in manufacturing a custom-fitted wearable article, the system comprising: a receiver for receiving a 3D digital last of an appendage representing a part of a human body, the 3D digital last comprising a plurality of vertices defining the shape and size of the appendage and having a central point and a main axis; a cylinder generator configured to provide a mesh cylinder within the 3D digital last, the mesh cylinder comprising a plurality of control points, and align a centre of the mesh cylinder with the central point and orienting the mesh cylinder along the main axis; a fixed anchor generator configured to generate opposing fixed anchor seams at respective opposing ends of the 3D digital last, each fixed anchor seam having a fixed location; and to stretch opposing ends of the mesh cylinder to the respective fixed anchor seams; a soft anchor generator configured to create a soft anchor within the 3D digital last, the soft anchor defining a set of vertices having a limited ability to move and being operative on a circumference of vertices located between the opposing ends of the mesh cylinder; and a physics engine configured to iteratively warp the cylinder mesh to minimise the tension between the opposing anchor seams and the soft anchor until a convergence threshold is achieved and to output the warped cylinder mesh as the 3D wearable article model.

According to yet another aspect of the present invention there is provided a method of creating a custom-fitted wearable article having a textured surface for printing, the method comprising: providing a planar design environment, the planar design environment enabling design of a textured surface of the custom-fitted article to be undertaken within a flat UV map using UVW coordinate mapping; applying a surface geometry to the flat UV map, the surface geometry comprising a plurality of control points with each control point having UVW coordinates; specifying texture elements on the UV map by using UVW coordinates; receiving a three-dimensional (3D) wearable article model for an appendage representing a part of a human body; morphing the texture elements created on the UV map to the custom 3D wearable article model using corresponding UVW locations on the 3D wearable article model; unifying the UV map and the 3D wearable article model into a unified mesh; and exporting the unified mesh to an output file for printing.

In some embodiments, the surface geometry comprises a mesh, a nurbs model or a plane (polygonal) model.

In some embodiments, the texture elements comprise regions of varying thickness of the UV map in the W coordinate direction. In one non-limiting embodiment, the flat UV map comprises a sole of a shoe and the 3D wearable article model is a model of a shoe.

Advantageously, the morphing step may comprise wrapping the flat UV map around the 3D wearable article model such that two opposing edges of the flat UV map join to form a single seam around the 3D wearable article model.

The method may further comprise manufacturing the 3D wearable article by printing the output file in a 3D printer.

In one non-limiting embodiment, the receiving steps comprises receiving a 3D wearable article model created by a method of creating a 3D wearable article model described above.

The method may further comprise communicating with a robotic tooling system to export the unified mesh to a robotics tooling system.

The morphing step in some embodiments comprises passing the 3D object model and the flat UV map through a voxel or implicit geometry field to unify the separate parts together.

The present aspect of the present invention also extends to a system for creating a custom-fitted wearable article having a textured surface for printing, the system comprising: a design engine for providing a planar design environment, the design engine being configured to: enable design of a textured surface of the custom-fitted article to be undertaken within a flat UV map using UVW coordinate mapping; apply a surface geometry to the flat UV map, the surface geometry comprising a plurality of control points with each control point having UVW coordinates; and specify texture elements on the UV map by using UVW coordinates; a projection engine configured to: receive a 3D wearable article model for an appendage representing a part of a human body; morph the texture elements created on the UV map to the custom 3D wearable article model using corresponding UVW locations on the 3D wearable article model; and unify the UV map and the 3D wearable article model into a unified mesh; and a mesh exporter configured to export the unified mesh to an output file for printing.

According to yet further aspect of the present invention there is provided a method of generating one or more toolpaths to guide a robot arm during manufacture of a custom-fitted wearable article, the method comprising: translating a received three-dimensional (3D) model of a wearable article into a two-dimensional (2D) UV coordinate map; determining an object boundary of the wearable article from the 2D UV map; generating at least one boundary offset line offset from the object boundary as a toolpath line; translating the at least one toolpath line to a 3D UV coordinate map; generating a plurality of points along the at least one boundary offset line, the distance between adjacent points representing a step in the toolpath for the robot arm; for each of the plurality of points, creating three orientation vectors: a first vector aligned in the normal direction to the point, a second vector aligned in the direction of travel between points and a third vector aligned towards the centre of the toolpath to limit rotation; and generating code from the vectors for controlling the operation of the robot arm in manufacturing the custom-fitted wearable article.

The method may further comprise determining the state of the object boundary; and closing the detected boundary of the object if the boundary is determined to be in an open state.

In some embodiments, generating at least one boundary offset line may comprise generating a plurality of boundary offset lines from the object boundary as a plurality of respective toolpath lines.

Preferably. The generating code step comprises generating code to move the robot tool head from a first one of the plurality of toolpaths to a second adjacent one of the plurality of toolpaths once the first tool path has been traversed.

In some embodiments, the generating code step comprises generating code to deposit glue to the wearable article at each point along the toolpath.

In one embodiment, the step of generating the plurality of points comprises determining the length of the at least one offset boundary line and dividing the length of the at least one boundary offset line into a predetermined number of equal length sections with each section being between adjacent points.

In another embodiment, the step of generating the plurality of points comprises creating a plurality of points along the at least one boundary line, wherein the points are spaced-apart by a predetermined distance.

Preferably, the method further comprises ensuring each point in the at least one toolpath lies on the surface of the 3D UV map.

In a non-limiting embodiment, the ensuring step comprises checking that each point in the at least one toolpath lies on the surface of the 3D UV map and pulling each point that does not lie on the surface of the 3D UV map to the surface.

Preferably the method further comprises assigning different weights to the vectors to control movement of the robot tool head differentially in different directions in use.

In some embodiments, the step of generating code comprises generating a code in a Computer Numerical Control (CNC) programming language. More preferably the step of generating code may comprise generating G-Code.

The step of generating code may comprises calculating a rotation angle of the robot tool head based on the vectors.

In an embodiment, the generated code is embedded within the 3D model of a wearable article.

The method of an embodiment further comprises determining an offset parameter; specifying the size of the offset; and applying the offset parameter to the generating at least one boundary offset line.

According to a yet further aspect of the present invention there is disclosed a system for generating one or more toolpaths to guide a robot arm during manufacture of a custom-fitted wearable article, the system comprising: a translator for translating a received 3D model of a wearable article into a 2D UV map; a boundary generator configured to determine an object boundary of the wearable article from the 2D UV map; and generate at least one boundary offset line offset from the object boundary as a toolpath line; the translator being configured to translate the at least one toolpath line to a 3D UV map; the boundary generator being configured to generate a plurality of points along the at least one boundary offset line, the distance between adjacent points representing a step in the toolpath for the robot arm; a vector creator configured for each of the plurality of points, to create three orientation vectors: a first vector aligned in the normal direction to the point, a second vector aligned in the direction of travel between points and a third vector aligned towards the centre of the toolpath to limit rotation; and a code generator configured to generate code from the vectors for controlling the operation of the robot arm in manufacturing the custom-fitted wearable article.

### BRIEF DESCRIPTION OF THE DRAWINGS

The present invention will now be described, by way of example only, with reference to the accompanying drawings, in which:

FIG. 1 is a flow diagram showing a prior art method of creating a custom digital last;

FIG. 2 is a series representations showing examples of digital lasts obtained using the prior art method of FIG. 1;

FIG. 3A are plan view representations of an exemplary digital last and foot scan with the length and width dimensions derived from a Bounding-Box using the prior art method of FIG. 1;

FIG. 3B are plan view representations of the exemplary digital last and foot scan of FIG. 3A rotated by 2 degrees, with the length and width dimensions derived from a Bounding-Box using the prior art method of FIG. 1;

FIG. 4A is a plan view line representation of an exemplary foot scan with the points defining the geometry obtained using the prior art method of FIG. 1;

FIGS. 4B and 4C are line representations of exemplary lasts showing inaccurate last measurements obtained using the prior art method of FIG. 1;

FIG. 5A is a line representation showing a 3D UV map with no substance;

FIG. 5B is a line representation showing the 3D UV map of FIG. 5A split into multiple components and unwrapped into a 2D space to build substance, according to a prior art method;

FIG. 6 is a flow diagram showing the prior art method of FIG. 5B;

FIG. 7 is a flow diagram showing a prior art method of manufacturing footwear;

FIG. 8 is a flow diagram showing a prior art method of creating robotic toolpaths;

FIG. 9 is a schematic block diagram showing an exemplary system for implementing an improved custom footwear creation system according to an embodiment of the present invention;

FIG. 10 is a schematic block diagram showing in greater detail the composition of the custom footwear creation system shown in FIG. 9;

FIG. 11 is a schematic block diagram showing in greater detail the Last Creator of FIG. 10;

FIG. 12A shows an illustration of four foot scans orientated in 6 degrees of freedom and landscaped as carried out by the extraction engine shown in FIG. 11;

FIG. 12B shows an illustration of mesh results obtained from foot scans obtained from the process carried out by the morphing engine shown in FIG. 11;

FIG. 13 is a flow diagram showing a method of creating a custom last carried out by the Last Creator of FIG. 11;

FIG. 14 is a schematic block diagram showing in greater detail the object orientation engine shown in FIG. 11;

FIG. 15A is a flow diagram showing the operation of the pitch/roll aligner of FIG. 14;

FIG. 15B is a flow diagram showing the operation of the yaw aligner of FIG. 14;

FIG. 16A is a schematic illustration showing two input scans in bounding bubble spheres, according to the method shown in FIG. 15A;

FIG. 16B is a line drawing illustrating the process of aligning a foot scan along the Y-axis according to the method shown in FIG. 15B;

FIG. 17 is a flow diagram showing an example of an object-specific algorithm carried out by the data extractor shown in FIG. 11;

FIG. 18 is a line drawing showing a foot dimension obtained using prior art methods and the method shown in FIG. 17;

FIG. 19 is a schematic block diagram showing in greater detail the UV Mapping System shown in FIG. 10;

FIGS. 20A to 20D are schematic line drawings illustrating the process carried out by the UV Mapping System of FIG. 19;

FIG. 21 is a flow diagram showing the method of creating a UV map as implemented by the UV Mapping System of FIG. 19;

FIG. 22 is a schematic block diagram showing in greater detail the custom footwear creator of FIG. 10;

FIG. 23A a series of line drawings illustrating the results of the process carried out by the morphing engine of FIG. 22 where there is no substance on the 2D UV map;

FIG. 23B is a computer-generated representation of a sole in a 2D configuration and then manipulated into a 3D configuration illustrating the process carried out by the morphing engine of FIG. 22 where elements have been created on the 2D UV map;

FIG. 24 is a flow diagram showing the operation of the custom footwear creator of FIG. 22;

FIGS. 25A to 25D are line drawings of a circle with a thickness illustrating the results of prior art deformation methods;

FIGS. 26A to 26D are line drawings of a circle with a thickness illustrating the results of a deformation method in accordance with an embodiment of the present invention;

FIG. 27 is a schematic block diagram showing in greater detail the robotic tooling system of FIG. 10;

FIG. 28A is a computer-generated representation of a custom sole created in a 2D plane and then manipulated into a 3D configuration showing a boundary line found in both the 2D and 3D representations as determined by the robotic tooling system of FIG. 27;

FIG. 28B is a computer-generated representation of the custom sole of FIG. 28A showing multiple robotic toolpaths, divided points, and normal vectors as determined by the robotic tooling system of FIG. 27;

FIG. 28C is a computer-generated representation of the custom sole of FIG. 28A showing multiple robotic toolpaths, divided points, and direction of travel vectors as determined by the robotic tooling system of FIG. 27; FIG. 29 is a flow diagram showing a method to generate limits for robotic tool heads as carried out by the limit encoder of FIG. 27;

FIG. 30 is a schematic illustration of a divided toolpath created using the method of FIG. 29, showing the directions of the U, V and W vectors for each point; and

FIG. 31 is a flow diagram showing operation of the code generator of FIG. 27 in generating instructions for robotic tools.

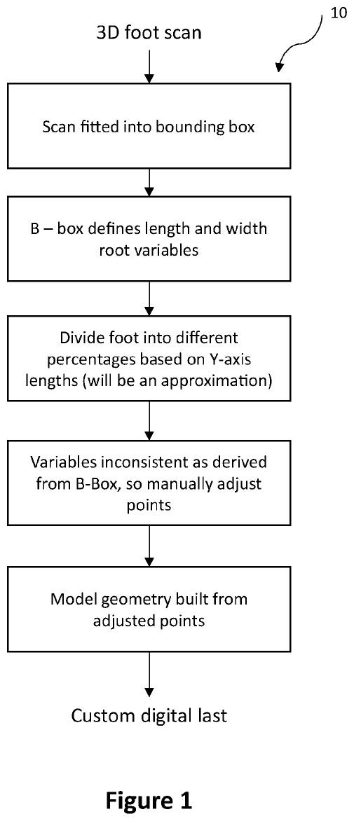

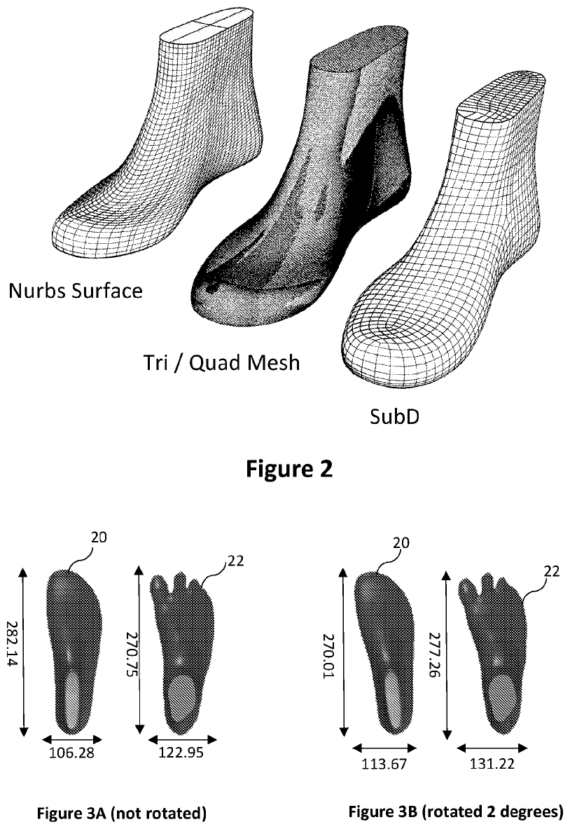

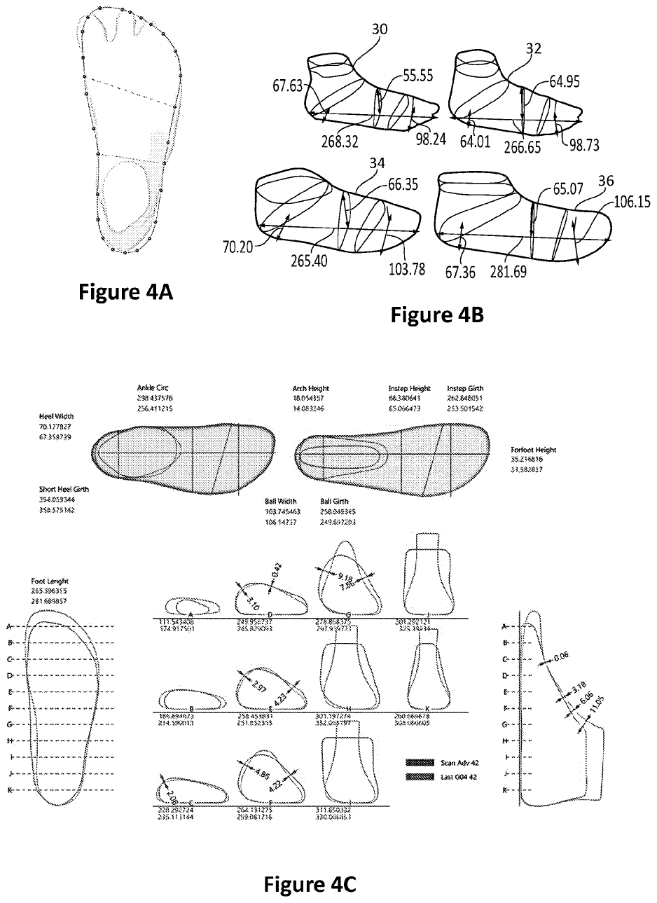

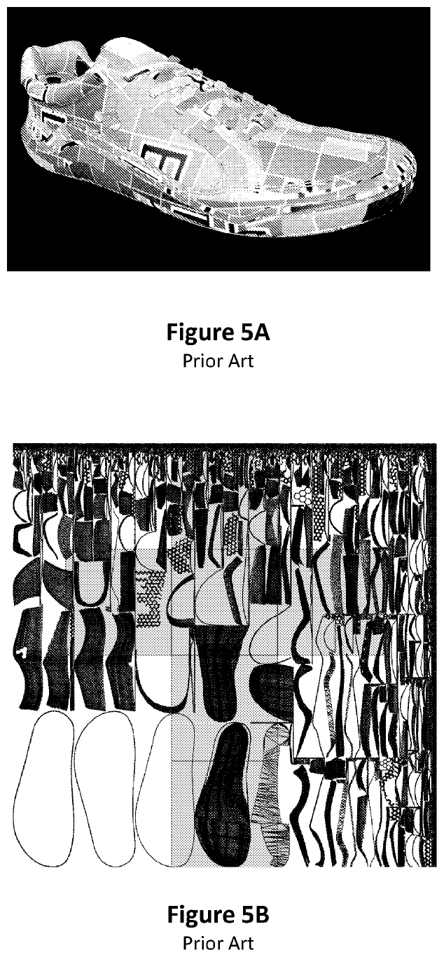

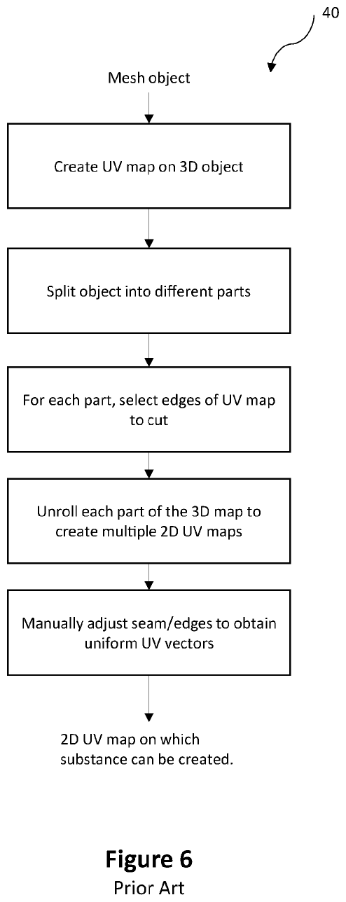

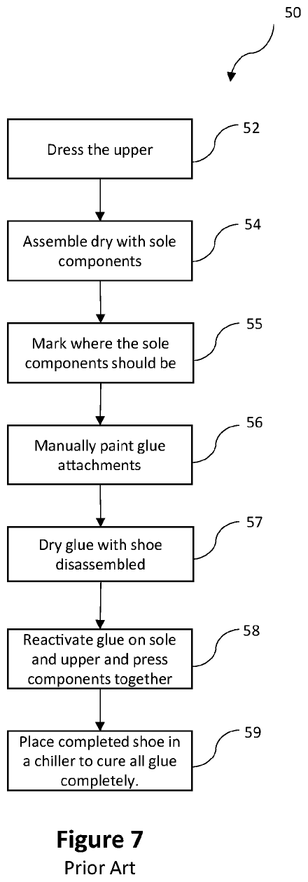

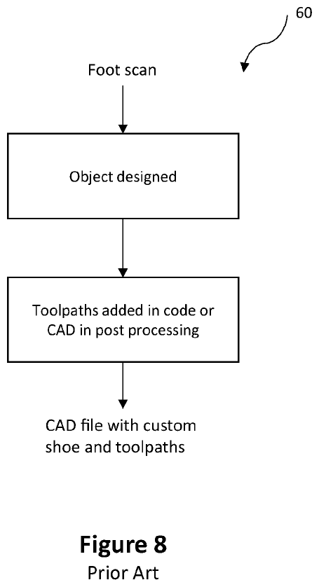

### DETAILED DESCRIPTION

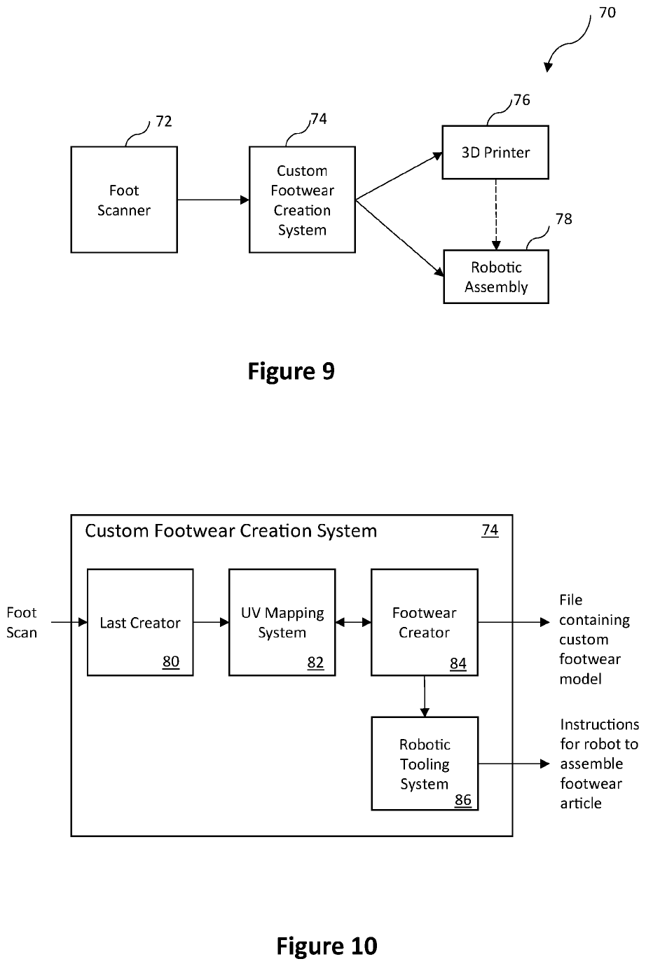

FIG. 9 shows the overview of an exemplary system 70 for implementing an improved method for designing and manufacturing custom-fitted wearable articles. While manufacturing custom-fitted footwear is discussed in detail, it should be appreciated that this system 70 can also be used to design and manufacture other custom-fitted wearable articles, such as gloves, helmets, or any other suitable example.

The system 70 for designing and manufacturing custom-fitted footwear (such as an article of footwear) includes a foot scanner 72, a custom footwear creation system 74, a 3D printer 76 and a robotic assembly 78. In use, the custom footwear creation system 74 receives a foot scan from the foot scanner 72, and outputs a file containing a 3D digital model of footwear that is custom fitted to the scanned foot. The file is output to a 3D printer 76, which prints the item of custom footwear. The custom footwear creation system 74 can also use the created 3D digital model to output a set of instructions to the robotic assembly 78 which can direct the assembly to assemble the item of custom footwear, for example by assembling a sole to an upper. While the embodiment illustrated in FIG. 9 shows a foot scanner 72, which will input a 3D scan of a user's foot to the custom footwear creation system 74, in other embodiments the input may be a 3D digital last. When a digital last is input to the custom footwear creation system 74, the system creates an item of footwear that is fitted to the provided last.

Elements of the custom footwear creation system 74 are shown in the block diagram in FIG. 10. The custom footwear creation system includes a Last Creator 80, a UV Mapping System 82, a Footwear Creator 84, and a robotic tooling system 86. While each component operates independently to perform their respective function, and as such are able to operate with functional components other than those shown in the current embodiment, the four components can operate together to provide an entire system for designing and manufacturing custom-fitted footwear. Accordingly, it is to be appreciated that each of the above four elements can form, by itself, an embodiment of the present invention independent of the other elements.

When operating together in the custom footwear creation system 74, the Last Creator 80 is operatively coupled to the UV Mapping System 82, which in turn is coupled to the footwear creator 84. The footwear creator 84 is also in communication with the robotic tooling system 86 to provide the 3D model of the footwear to better control the robotics assembly to put together the components of the article of footwear. These components can be created by the 3D printer 76 in response to being provided with the 3D model of the item of footwear. The input to the custom footwear creation system 74 is a 3D foot scan, which is input to the Last Creator 80. The scan can be generated using conventional scanning devices and so is not described further herein. The Last Creator 80 creates a custom (digital) last which perfectly models the scanned foot and provides the custom last to the UV Mapping System 82. The UV Mapping System 82 generates a 3D UV map (that is, a mesh where each vertex has U, V, and W orthogonal co-ordinates) that wraps around the custom last, and the UV mapped last is then pushed to the footwear creator 84. The footwear creator 84 designs and builds a 3D digital model of footwear (such as an entire shoe or a sole of a shoe) that fits perfectly to the custom last, communicating with the robotic tooling system 86 to generate instructions for the robot assembly 78 to assemble the footwear article. For example, the robotic tooling system 86 can generate robotic toolpaths which specify how a robot arm is to move during the assembly of the item of footwear. The output of the footwear creator 84, and thus one of the outputs of the custom last creation system 74, is a file containing a 3D digital model of an item of custom-fitted footwear, that is suitable for 3D printing.

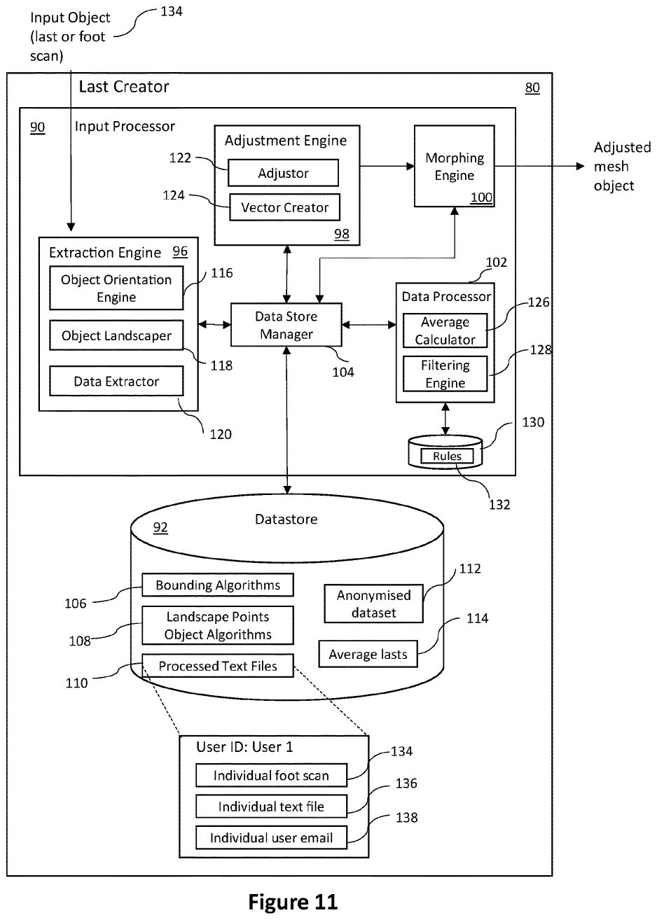

The Last Creator 80 within the custom footwear creation system 74 is shown in more detail in the block diagram in FIG. 11. The Last Creator 80 comprises several components which are shown in FIG. 11 and described below. The Last Creator 80 includes an input processor 90 in communication with a datastore 92. Whilst the datastore 92 has been shown in FIG. 11 to be an element provided within the Last Creator 80, in another embodiment, the datastore 92 can be provided remotely, for example as cloud storage. The input processor 90 comprises an extraction engine 96, an adjustment engine 98, and a morphing engine 100 coupled to the adjustment engine 98. The input processor 90 also includes a data processor 102 and a datastore manager 104, where the datastore manager 104 is the component through which the extraction engine 96, the adjustment engine 98, the morphing engine 100, and the data processor 102 communicate with the datastore 92. The datastore 92 stores bounding algorithms 106, landscaped points and corresponding object algorithms 108, processed text files 110, an anonymised dataset 112, and stored average lasts 114, each of which is described in greater detail later.

As illustrated in FIG. 11, the extraction engine 96 comprises an object orientation engine 116, an object landscaper 118, and a data extractor 120, which all operate together to carry out the functionality of the extraction engine 96. Similarly, the adjustment engine 98 comprises an adjustor 122 and a vector creator 124.

The Last Creator 80 functions to create a custom digital last for any input 3D foot scan. The Last Creator 80 also stores all scan input data, and categorises the data into different groups, for example into groups of different shoe sizes. The categorised data can be used to calculate more accurate average lasts across a range of groups.

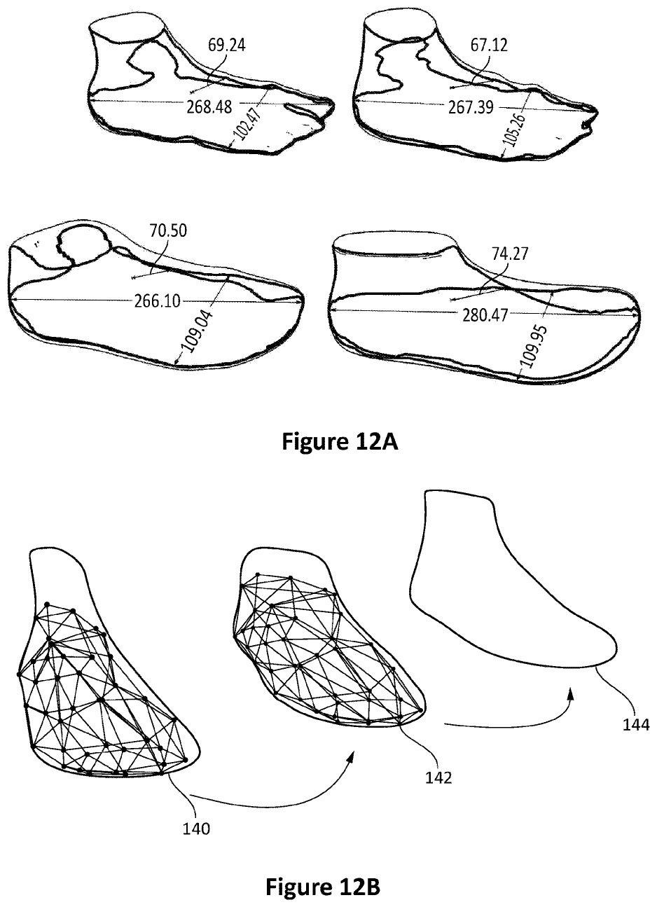

In use, a mesh object 134 such as a foot scan is fed into the extraction engine 96. The scan of the object is first orientated in all 6 degrees of freedom by the object orientation engine 116, which uses a plurality of different bounding algorithms 106 including Euclidean, Welzl, Bouncing Bubble, and minimal B-box algorithms to get the most accurate orientation of the object. The object landscaper 118 then ‘divides’ the orientated object using landscaped points 108, which are retrieved from the datastore 92 by the extraction engine 96 via the datastore manager 104. By ‘division’ it is meant that the scan is represented by a set of predetermined parameters each of which is defined as a specific measurement between specific landscaped points 108. The landscaped points 108 are a defined set of points, specific for each type of input object, and configured to divide the object at the same geometric position independent of the individual object. For example, in a footwear application embodiment, 46 landscaped points are used, and these divide all input foot scans at the same 46 geometric positions, and thus the same 46 measurements on each scan can be determined, such as the distance between the heel and big toe. Examples of four foot scans that have been orientated in the Y-axis, aligned and landscaped are shown in FIG. 12A (note all four scans are aligned horizontally FIG. 12A). While 46 landscaped points are used in this embodiment, only six are shown in FIG. 12A providing three parameters for the reader's clarity.

Once the object landscaper 118 divides the object using the landscaped points 108, the data extractor 120 extracts these points and corresponding data from the landscaped object using landscape points object algorithms 108, which are also retrieved from the datastore 92 via the datastore manager 104. The corresponding data includes each landscaped point's position in 3D space, and information on the relationship between each landscaped point, which allows various foot dimensions to be calculated. These algorithms used to extract such dimensions (descriptive parameters) are object specific and developed specifically for the chosen set of landscaped points. For example, as mentioned above, in a footwear application where there are 46 defined landscaped points, a landscape points object algorithm 108 that calculates the difference between point 0 (which falls at the heel of the foot) and point 15 (which falls at the big toe) is used to find the length of the foot. Various other dimensions are also extracted using different landscape points object algorithms 108. This method of deriving foot measurements from a scan is more accurate than the prior art methods discussed, where dimensions are typically approximations due to manual processes used to orient the scan and define the foot geometry.

Returning to FIG. 11, the data extractor 120 outputs the landscaped points and corresponding data, alongside the original input object 134 and an associated user ID, to the datastore manager 104. The datastore manager 104 splits this data into two separate datasets. Firstly, all of the received data is written to the datastore 92, where it is stored as a processed text file 110. A separate processed text file 110 is stored for each input scan 134, and each file contains the input scan object 134, the user ID, and a text file 136 containing the landscaped points and their positions in 3D space, and the extracted measurements. Also, a communications address 138, such as an email may also be provided. Separately, the data store manager 104 creates an anonymised version of the data 112. To create the anonymised dataset 112, the datastore manager 104 removes the original input object 134, communications address 138 and associated user ID from the data, and creates a dataset containing only the landscaped points, their position in 3D space, and the associated extracted measurements. The anonymised dataset 112 is also sent to be stored in the datastore 92.

As mentioned briefly above, the Last Creator 80 can be used to create accurate average lasts 114, and this process uses the stored anonymised dataset 112. The data processor 102 includes a filtering engine 128, an average calculator 126 and is in communication with a local datastore 130 containing rules 132, and it is the data processor 102 that is configured to calculate average lasts 114. The data processor 102 retrieves the anonymised dataset 112 from the datastore 92, and the filtering engine 128 filters the data, selecting only specific categories (characteristics). Examples of categories are male, female, shoe size, foot width, and age, but many other categories are possible. To carry out the categorisation process, the filtering engine 128 retrieves a rule 132 from the rules 132 stored in the local datastore 130 and applies the rule 132 to the entire anonymised dataset 112. For example, to filter the data and retrieve only data from male foot scans, a rule 132 that states that when the forefoot length (a measurement extracted from the scan 134 by the data extractor 120 and stored) is between 10 mm and 12 mm, the foot belongs to a male may be used. This rule 132 is retrieved from the local datastore 130 by the filtering engine 128 and applied to the entire anonymised dataset 112, and returns only data from scans where the forefoot length is between 10 and 12 mm. Several rules 132 are stored and can be applied to the anonymised dataset 112, in order to filter for various different categories, such as shoe size.

The filtered data is output from the filtering engine 128 to the average calculator 126, which calculates the average of the filtered data, including averaging each landscaped points position in 3D space, and averaging the associated foot measurements. This process creates an ‘average’ last for that specific filtered dataset. The average last 114 includes the averaged landscaped points for that object, and associated foot dimensions. In the example discussed above, when the filtering engine 128 selected only foot scans from males, the filtered dataset is output to the average calculator 126, which calculates average landscaped points and foot dimensions for the filtered dataset, and as such creates an average model of a male foot: an average last 114. The average last 114 is sent to the datastore 92, via the datastore manager 104, to be stored under the category ‘male’. As more foot scans are input to the Last Creator 80, more data is added to the anonymised dataset 112 and so more data is used for average calculations for any chosen category (such as shoe size). In this way, the stored ‘average’ last 114 in each category becomes more accurate. Accordingly, by grouping the data into different discrete sizes (Euro size 39, 40, 41 . . . etc), a better average size of footwear for each group can be obtained and therefore a better fitting discrete size for each shoe size, namely a specific size that will be a better fit for more people as it is based on real data. Therefore, the Last Creator 80 can be used to provide an average last across a range of different foot sizes or other categories, as well as to create a custom last perfectly matched to an individual, which is described below.

As illustrated in FIG. 11, once the input object 134 has been processed by the extraction engine 96 and the data has been stored, the adjustment engine 98 retrieves the processed file 110 of the input object 134, and a stored average last 114 last from the datastore 92, via the datastore manager 104. The adjustor 122 adjusts the landscaped points on the average last 114 to match the landscaped points for the input scan object 134. This results in two sets of data: the original landscaped points on the average last 140, and the adjusted points 142. The vector creator 124 calculates the difference in positions between the original 140 and adjusted 142 points, and the resultant vector is output to the morphing engine 100. The morphing engine 100 then morphs the object, using this vector, from the stored object (an average last 114) to a new adjusted object (custom last 144). The morphing process is illustrated in FIG. 12B. In this way, a custom last 144 that accurately models the scanned foot is produced. The adjusted object 144 is output from the Last Creator 80 to the UV Mapping System 82.

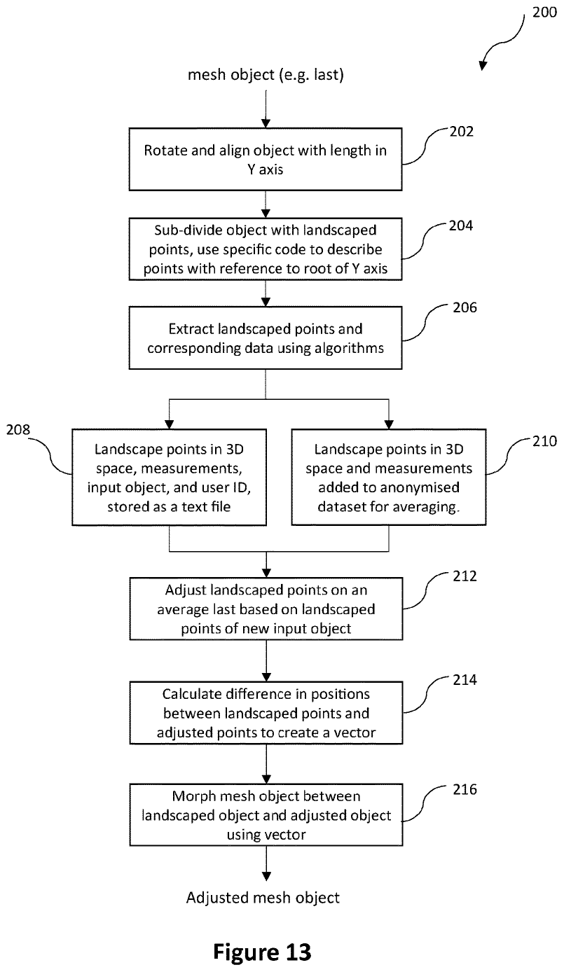

The overview of the process 200 carried out by the Last Creator 80 to create a custom last 144 is illustrated in FIG. 13. A mesh object 134 (such as a 3D scan) is input to the Last Creator 80, and the object is rotated and aligned in all six degrees of freedom at Step 202. The object is then sub-divided using landscaped points, which are described in reference to the root of the Y-axis, at Step 204. At Step 206, the points and corresponding data are extracted based on specific algorithms, and the data is then written to the datastore, both as a text file that contains the user ID, the landscaped points and corresponding distances, and the input object at Step 208, and also as anonymised data that just contains landscaped points and scan measurements at Step 210. At Step 212, the landscaped points on a stored average last are adjusted to correspond to the landscaped points on the 3D scan input, and then the difference between the originally landscaped points and the adjusted points is calculated at Step 214 to produce a vector. At Step 216, this vector is used to morph the stored average last from an object corresponding to the average landscaped points to an object corresponding to the adjusted points. Therefore, an adjusted mesh object, specifically an adjusted last 144 that perfectly models the foot of the input scan, is output from the Last Creator 80.

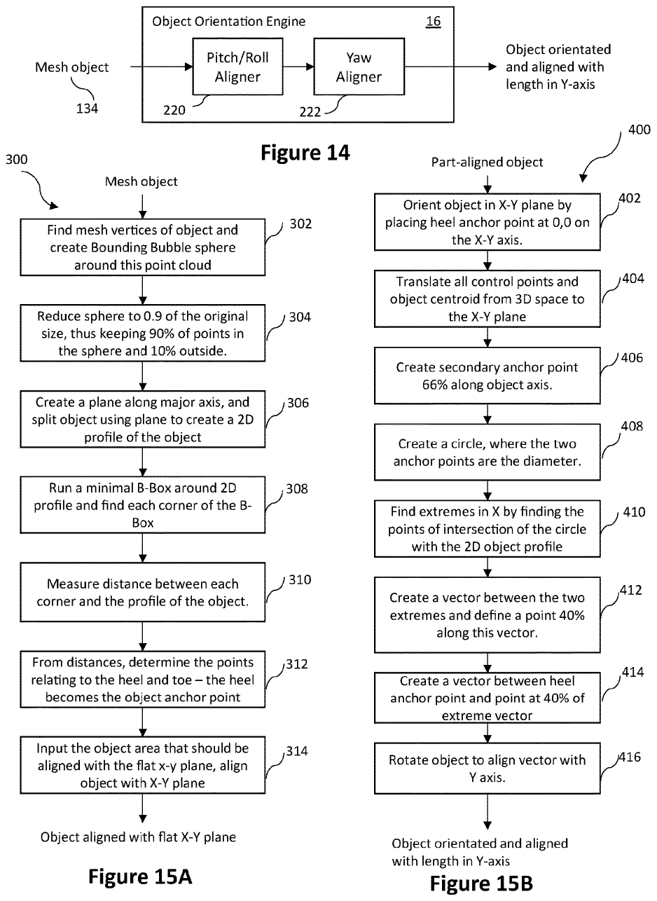

The object orientation engine 116 of FIG. 11 is described in more detail in the block diagram in FIG. 14. The object orientation engine 116 comprises a pitch/roll aligner 220, and a yaw aligner 222. In use, the mesh object 134 is first fed into the pitch/roll aligner 220, which orients the object 134 with the X-Y plane, and then the yaw aligner 222 aligns the object 134 with length in the Y-axis. The output of the object orientation engine 116 is the object 134 orientated and aligned in all six degrees of freedom.

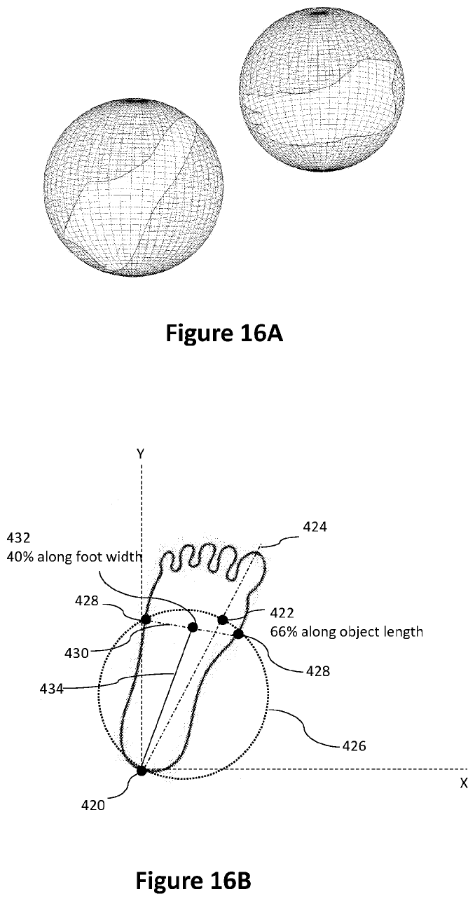

The process 300 carried out by the pitch/roll aligner 220 is illustrated by the flowchart in FIG. 15A. First, at Step 302, all mesh vertices of the object are found, and a Bounding Bubble sphere is created around this point cloud. An example of Bounding Bubbles created around two different input scans, which have different orientations, is shown in FIG. 16A. At Step 304, the centroid of the Bounding Bubble sphere is determined, and the sphere is scaled to 0.9 around the centroid so that 90% of the mesh vertices of the object remain in the sphere, and 10% will be outside of the sphere. The 10% of points outside of the sphere will be the points at the (two) extremes of the object. Scaling the sphere to 0.9 is effective when orientating a 3D foot scan or digital last, as the points at the toe and heel will remain outside of the sphere, and so a major axis defining the direction of the input scan or last can be determined. However, the value used to scale the sphere is dependent on the object being orientated, and so is varied based on the application. At Step 306, a best fit plane fit to the points at the two extremes of the input object is created to define an axis through the object. The plane splits the object and so provides a 2D profile of the object, where the profile is a flat plane curve (a curve that has been split by a plane). The 2D profile is required in subsequent operations to further define and orientate the object.

In more detail, creating the plane (and thus the 2D profile) involves averaging the X, Y, and Z co-ordinates of each point outside of the Bounding Bubble sphere to provide a singular location in 3D space. A vector in each of the X, Y, and Z directions is created, where the length of each vector is the average value in each of the X, Y, and Z directions respectively. Using this singular point and the three vectors, a best fit plane is created, which can split the object and obtain a 2D profile.

Returning to FIG. 15A, at Step 308, the system runs a minimal bounding box (a method in which a box is twisted iteratively until the minimal area is found) around the 2D profile of the input object, and finds each corner of the minimal bounding box. The distance from each corner of the bounding box to the object profile is measured at Step 310, and these distances, alongside the distances between the four corners of the bounding box, are used to determine which of the corners of the B-box correspond to the heel and toe of the input scan. Logic rules are used, for example it can be determined that at the corner where the distance to the profile is longest, there is no ankle, and so this point must be on the toe side of the foot. The relationship between this point and the three other corner points allows the point corresponding to the heel on the 2D profile to be found, and this point is defined as the anchor of the object at Step 312. The anchor is important, because as a designated point on the object, it is the part of the object from which subsequent functions and algorithms are based. In the footwear application discussed, the heel is used as the anchor, but in other applications other points can be used. For example, when orientating a scan of a hand, a point at the bottom palm may be chosen as an anchor. Finally, at Step 314, the area of the object that should be aligned with the flat X-Y plane is specified. In footwear applications, this is chosen as the sole of the foot. In this way, any input last or scan can be orientated to a flat plane.

This part-aligned object is then fed to the yaw aligner 222, and the process 400 carried out by the yaw aligner is described in the flowchart in FIG. 15B. Reference is also made to FIG. 16B, which is a line drawing illustrating the method carried out by the yaw aligner 222. FIG. 15B describes that first, the anchor point at the heel is used to create an orientation plane in the object and this plane is used to orient the object to the X-Y plane at Step 402. Orientating the object to the X-Y plane involves moving the heel anchor point to the root of the Y axis (X-Y co-ordinates (0,0)). This is illustrated in FIG. 16B, which shows the heel anchor point 420 at co-ordinates (0,0) on the X-Y axis. The area and centroid of the object, and all object control points (the vertices of the mesh) are then translated from 3D space to the flat X-Y plane at Step 404.

Since the direction of the input scan, and UVW co-ordinate points corresponding to the heel and toe were defined previously using the best-fit plane, the resultant 2D profile, and the bounding box, the length of the object is known. Therefore, a secondary anchor point 422 can be created on the major axis 424 at 66% along the length of the object at Step 406. This point is also illustrated in FIG. 16B. The value of 66% is chosen because in footwear applications, when the input object is a scan or a digital last, 66% along the foot length is, on average, the widest part of the foot, and thus the extreme points of the foot geometry in the X-direction can be found. At Step 408, a circle 426 is created where the distance between the heel anchor point 420 and the secondary anchor point 422 at 66% corresponds to the diameter of the circle 426, and the intersections 428 of the circle 426 with the 2D profile of the object are found at Step 410. The two intersections 428 correspond to the widest part of the foot: the extremes of the foot geometry in the X-direction. At Step 412, a vector 430 is created between the two extreme points 428, and a point 432 40% along this distance is defined. The distance of 40% is used because, on average, a distance of 40% corresponds to the position of the middle toe, and so the centre of the foot. Since the input scan is aligned with the X-Y plane, the object orientation engine 16 can determine if the input scan is of a right or left foot, and therefore knows from which intersection 428 (medial or lateral side of the foot) to measure 40% of foot width. A vector 434 is created between the heel anchor point 420 and the point 432 at 40% of foot width at Step 414. This vector 434 is the root of the object. Finally, at Step 416, the object is rotated using the heel anchor point 420 as the centre of rotation to align the vector 434, and thus the input object, with the Y-axis. In this way, the object is orientated and aligned in all six degrees of freedom.

This method of orientation allows any input scan, from any source, to be accurately and efficiently aligned and orientated in all six degrees of freedom, independent of the original orientation of the input scan. Any input object can be described with reference to the heel 420 and secondary 422 anchor points, and the variation in input objects is described by the variation in the points around the anchors 420, 422.

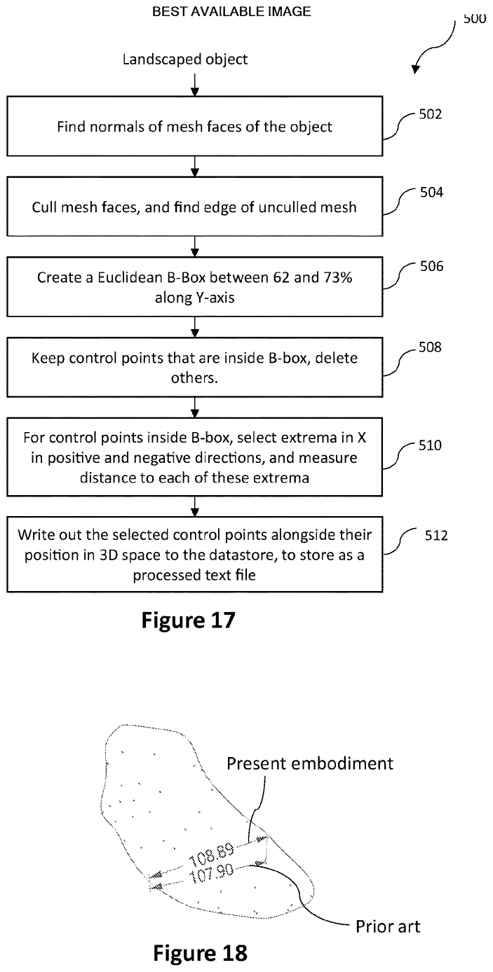

As previously described, the aligned object is then landscaped by the object landscaper 118, and the data extractor 120 extracts the landscaped points, their positions in 3D space, and various dimensions that are calculated using the landscape points object algorithms (object specific) 108. An example of an algorithm 500 used by the data extractor 120, an algorithm to determine the ball girth of a foot, is shown in detail in the flowchart in FIG. 17. The landscaped object is input to the data extractor 120, and at Step 502, the normals of all mesh faces on the object are found. The mesh faces are then culled based on the normals' angle to the Z-axis, and the edge of the unculled mesh is found at Step 504. At Step 506, a Euclidean B-box is created, the length of the B-box extending between 63 and 72% along the Y-axis, and the width of the B-box capturing the entire width of the scanned foot. The values of 63% and 72% are used in this example as the ball girth of the foot (the widest part) typically occurs between 63% and 72% along the length of the foot (from the heel). Object points that are not within this B-Box are deleted at Step 508. Then, at Step 510, for points within the B-Box, the extreme points in the positive and negative direction along the X-axis are selected. It should be noted that different combinations of these directional distances are required for different feet. For example, for a right foot, on the medial side of a scan a negative X-axis number is used and on the lateral side of the scan a positive X-axis number is used. The points are described with reference to the heel anchor point 420, and so their exact location in 3D space is known. The distance between the two points can thus be calculated, resulting in an accurate measure of the foot at its widest point, and thus the ball girth. Returning to FIG. 17, finally, at Step 512, the selected control points, alongside their position in 3D space, is written out to the datastore 92.

An example of the ball girth measurement obtained from a foot scan using the prior art method and using the method of the present embodiment is shown in FIG. 18. In the prior art examples described, distances are measured on the flat plane, and based off a percentage. Thus, the result is always an approximation and therefore inaccurate, as highlighted in FIG. 18. The method of the present embodiment calculates the distance in 3D space, which, as shown, results in a more accurate measure of the ball girth of the foot.

UV Mapping. As illustrated in FIG. 10, the adjusted object, or custom last, from the Last Creator 80 is provided to the UV Mapping System 82. In other embodiments, a digital last can be provided from another source as the UV Mapping System 82 is independent of the Last Creator 80. The UV Mapping System 82 creates a uniform 3D UV map around the adjusted object, which is required for subsequent addition of structure and texture during footwear design.

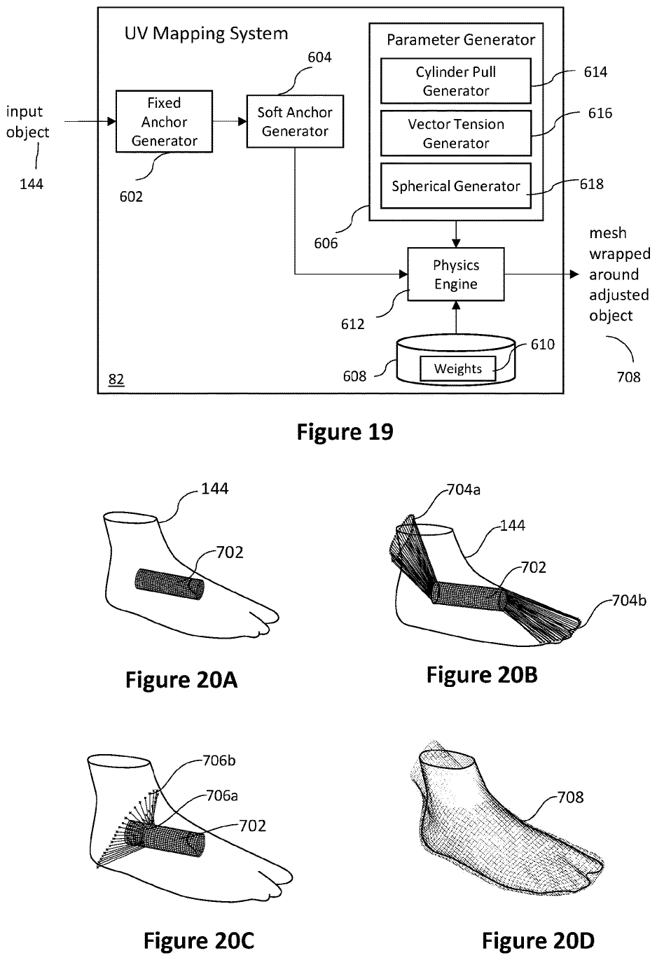

The UV Mapping System 82 is shown in greater detail in the block diagram in FIG. 19, and includes a fixed anchor generator 602, a soft anchor generator 604, a parameter generator 606, and a datastore 608 containing weights 610. The UV Mapping System 82 also includes a physics engine 612, which receives parameters from the parameter generator 606, weights 610 from the datastore 608, and the object with fixed anchors and soft anchors from the soft anchor generator 604. The physics engine 612 outputs the adjusted object with a 3D UV map wrapped around it. The parameter generator 606 itself comprises three components: a cylinder pull generator 614, a vector tension generator 616, and a spherical generator 618.

When the four components of the footwear creation system 74 operate together, the adjusted object 144 from the Last Creator 80 is input to the UV Mapping System 82. However, the UV Mapping System 82 can also receive a 3D foot scan as an input and create a 3D UV map of the input scan.

In use, the fixed anchor generator 602 receives the object 144 (a 3D scan or a last) and generates a mesh with fixed anchors within the adjusted object 144. This includes first creating a UV mesh cylinder 702 inside the adjusted object 144 and aligning the centre of the cylinder 702 with the centre of the adjusted object 144 (found through calculating the area of the adjusted object). This is illustrated in FIG. 20A. The fixed anchor generator 602 creates two seams at opposing ends of the object 144: a north anchor seam 704a and a south anchor seam 704b, as illustrated in FIG. 20B. When the adjusted object 144 is a foot scan or a last, the north anchor seam 704a is created at the ankle of the foot, and the south anchor seam 704b is created along the toes of the foot. The two seams, the north 704a and south 704b anchor seams, are the locations where the UV vectors of the mesh will converge. To create the north 704a and south 704b anchor seams, the fixed anchor generator 602 finds the normal of all mesh faces of the adjusted object 144, and culls the mesh based on the normals' angle to the Z-axis. The two edges of the unculled mesh are found, and these become the north 704a and south 704b seams. Each seam 704a, 704b is divided using a number of points, where the number of points corresponds to the number of mesh vertices (i.e. the number of points on the circumference) on each side of the mesh cylinder 702. Therefore, as the density of the mesh cylinder increases, the number of points along each seam will Increase. The density of the mesh cylinder 702 can be varied, but enough points are required to accurately describe the foot geometry. An example of a mesh that may be used in a footwear application is a 55×55 grid or a 25×55 grid. As the density of the mesh increases, so does the resolution of the UV map. However, so does the processing time of any calculations.

The fixed anchor generator 602 calculates vectors between the control points on each side of the mesh cylinder 702 to the corresponding points on each seam 704a, 704b, and moves the mesh to the seam using the vectors. The points on the north 704a and south 704b anchor seams are the north and south fixed anchors for the mesh. The fixed anchors are fixed in 3D space and cannot move. The output from the fixed anchor generator 602 is therefore the adjusted object 144 with the mesh cylinder 702 extending to the north 704a and south 704b fixed anchor points, as illustrated in FIG. 20B.

The output of the fixed anchor generator 602 is provided to the soft anchor generator 604, which creates a soft anchor 706 within the adjusted object 144. The soft anchor 706 is a set of points which, unlike the fixed anchors 704, have the ability to move in 3D space. In the footwear application described a heel to instep soft anchor is an effective soft anchor, and this is illustrated in FIG. 20C. FIG. 20C shows the start 706a and end 706b points of the soft anchor, which correspond to the initial placement of the soft anchor 706a by the soft anchor generator 604, and the position of the soft anchor points 706b after the physics engine 612 warps the mesh. Other soft anchors may be used, however the heel to instep soft anchor 706 is extremely effective in a footwear application. The output of the soft anchor generator 604 is therefore the adjusted object 144 with the mesh cylinder 702, where every control point on the mesh cylinder can be defined as either a fixed anchor 704, a soft anchor 706, or neither.

Every control point on the mesh cylinder 702 has a weight 610 associated with it, and the weight 610 is dependent on if the point is a fixed anchor 704, a soft anchor 706, or neither. The weight 610 determines how much each control point can move relative to every other control point on the object 144 and guides the control points from their source to their destination. For example, the fixed anchors 704 have a high weight 610 such as 100, and so these points will not move. The soft anchors 706 have some pliability, and so a medium weight 610 is assigned, such as 30. All other control points are free to move in 3D space, and so a low weight 610, such as 2, is assigned to these points. All weights 610 are pre-assigned to the mesh cylinder control points and stored in the datastore 608.

The adjusted object 144 with the mesh cylinder 702 and fixed 704 and soft 706 anchors is output to the physics engine 612, which also receives parameters from the parameter generator 606, and retrieves the list of associated weights 610 from the datastore 608. The parameter generator 606 generates three parameters, a cylindrical pull 614, a vector tension 616, and a spherical 618, which are assigned to cylinder control points (mesh vertices of the cylinder 702) to guide and control the movement (warping) of the mesh. Generation of the three parameters creates 9 vectors for each control point, and the associated weight 610 for that control point is retrieved and assigned to the vectors. Therefore, the parameters and weights determine how much each control point on the mesh can move. Each of the parameters generated is discussed in detail below.

The cylinder pull generator 614 creates a pull for the cylinder control points towards the adjusted object 144, to move the control points outwards towards the surface of the object 144. To do this, the closest point on the surface of the object 144 to the cylinder control point is found, and a vector is created between the two points. This vector is assigned a weight for movement, and the weight is object-specific. In the footwear application discussed, this is assigned to be 100 (and thus movement between these two points is low), but in other applications, other weights will be used.

The parameter generator 606 also comprises a vector tension generator 616, which assigns a vector tension between cylinder control points, which is required to pull all points together and ensure the mesh maintains its structure. To create the vector tension, all internal mesh edges (i.e. the edges of the individual squares that make up the mesh) of the mesh cylinder 702 are found, and the edges are transformed into vectors. A weight is then assigned to each vector (via the control points associated weight 610 stored in the local datastore 608), and in the footwear example described, the assigned weight is 60.

The final component of the parameter generator 606 is the spherical generator 618, which creates a spherical for all cylinder control points. The spherical is the average vector for each control point, and to create this parameter, for each control point, the five closest control points are found. Vectors are created between the control point and the five nearest neighbours, and the five vectors are averaged to create an average vector for that control point. The weight 610 assigned to this control point is assigned to the vector to guide movement from the control point's original location to the location of the average vector. In the footwear example, this is chosen to be 30.

The physics engine 612 receives the vectors generated by the parameter generator 606 and the weight 610 assigned to each point on the mesh and operates iteratively to move the mesh by moving the control points from their start position in 3D space using the parameters and weights 610. The aim is to move the control points to find the minimal tension between the north 704a and south 704b anchor seams, which indicates a good fit of the mesh to the input object 144. Using the heel to instep soft anchors 706, 2000 iterations are required to achieve a suitable warped mesh, and this takes approximately 5 seconds to compute. In every iteration, a vector is calculated (3 vectors add up to the mass addition of how far the point is being pushed), and the associated weight 610 for the control point is assigned to that vector. At the end of each iteration, the system 82 can determine how much the mesh has moved. The parameters and vector are re-calculated, the same weight 610 applied, and the process is repeated for a plurality of iterations, in this embodiment 2000 iterations are used.

The number of iterations, and therefore the computation time, may change depending on the soft anchors 706 used and the input object 144. 2000 iterations was chosen for this application, as the mesh always converges after this number of iterations. An alternative would be to measure the convergence number for the mesh against a convergence threshold and run the physics iteration until the convergence threshold is reached.

The physics engine 612 outputs the adjusted object with a UV map wrapped around the adjusted object 708, as illustrated in FIG. 20D. Unlike prior art methods, the UV map is uniform in 3D space, and as the object does not need to be sectioned and unwrapped into separate 2D objects, the edges do not need to be manually adjusted to create uniform UV vectors at each edge.

The process 800 carried out by the UV Mapping System 82 is outlined in the flowchart in FIG. 21. As illustrated, the adjusted object 144 is input to the UV Mapping System 82, and at Step 802, a mesh cylinder is created and orientated within the adjusted object. At Step 804, a north and south anchor seam are created, and at Step 806, these seams are divided using the same number of points as there are on each edge of the mesh cylinder. The cylinder edges are moved to the points on each seam, and these points become the fixed anchors for the mesh at Step 808. Soft anchors are created at Step 810, and then, in parallel, three parameters are generated: a pull for cylinder control points at Step 812, a vector tension between cylinder control points at Step 814, and a spherical for cylinder control points at Step 816. Once these parameters are created, at Step 818, the physics engine retrieves the assigned weight for each control point and assigns the weights to the vectors. The physics engine then calculates movement of the mesh for 2000 iterations at Step 820, allowing the output from the UV Mapping System 82 to be a mesh that is pulled around the adjusted object. This creates a custom 3D UV map that is bespoke to the input object.

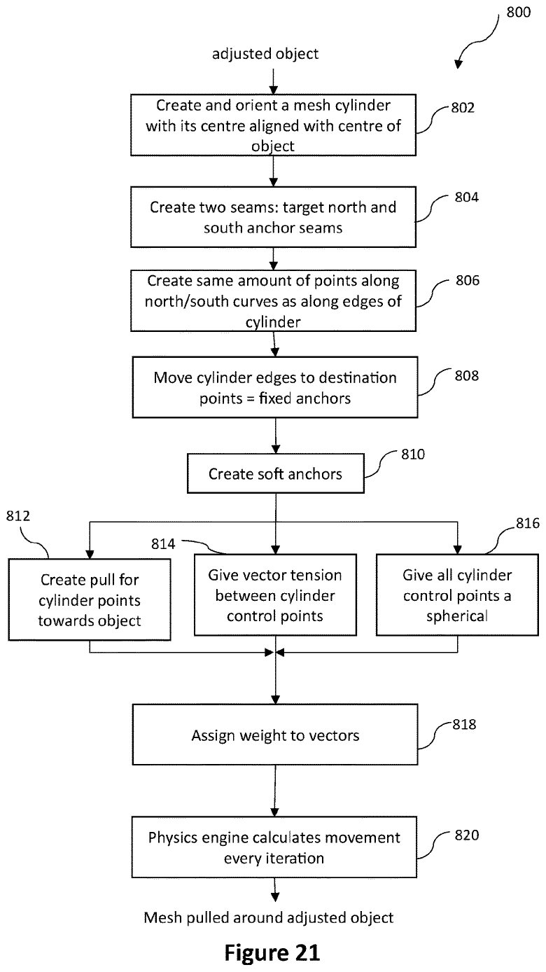

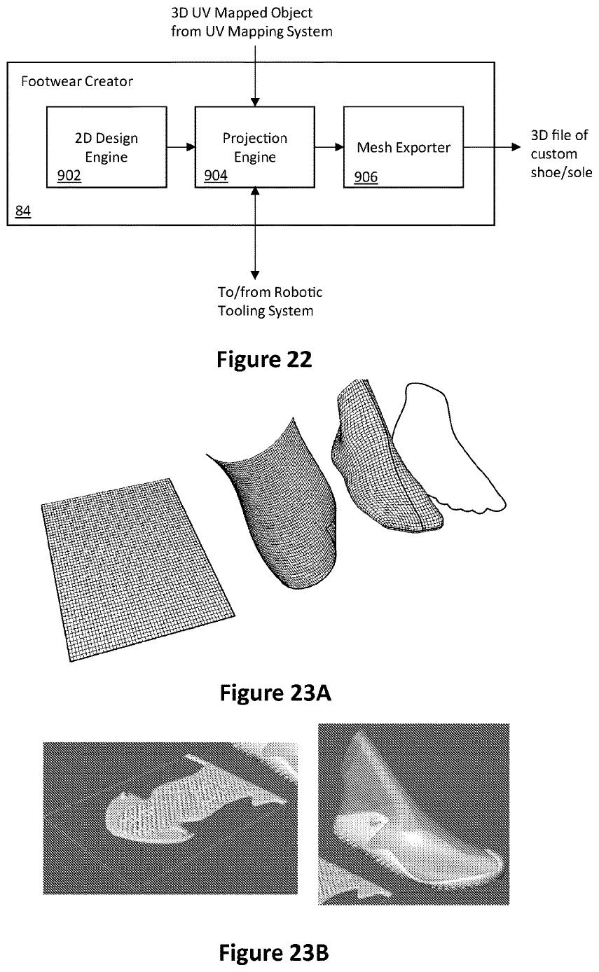

Footwear/Sole Builder. FIG. 10 shows that when operating in the custom footwear creation system 74, the 3D UV mapped object is output from the UV Mapping System 82 to the footwear creator 84, for design of custom-articles. In other embodiments, the input can be a UV 3D mapped object obtained from a different source. The components of the footwear creator 84 are shown in the block diagram in FIG. 22. The footwear creator 84 includes a 2D design engine 902, a projection engine 904, and a mesh exporter 906. The 2D design engine 902 is an algorithm-driven engine, and the output of the 2D design engine 902 is an article designed on a 2D UV map, which is provided to the projection engine 904. The projection engine receives the 3D UV mapped object 708 from the UV Mapping System 82, and translates the 2D design to the 3D object, namely the projection engine 904 projects the 2D design onto the 3D UV mapped object 708. A practical non-limiting example of this is the creation of a bespoke sole for footwear in the 2D domain and then wrapping this around the 3D digital model of the article. The projection engine is also in communication with the robotic tooling system 86. The projection engine 904 provides its output to the mesh exporter 906, which outputs a 3D file of a custom-fitted article, which is suitable for 3D printing. In this example, custom-fitted footwear is described.

The 2D design engine 902 designs and builds the footwear on a 2D UV map. This design engine 902 creates a flat plane UV map by creating a rectangle, and then applying a surface geometry in this rectangle. The surface geometry can be any type of surface geometry, for example a mesh, a nurbs (Non-uniform rational basis spline) model or a plane (polygonal) model, and each control point of the surface geometry will have U, V, and W co-ordinates. The instance where a mesh is applied is discussed, and in this instance each vertex on the mesh has U, V, and W coordinates. The 2D design engine 902 then adds substance to the UV flat map, which comprises specifying thicknesses and building features across different parts of the mesh. In this way, an entire article of footwear is designed on the flat plane UV map. This article can be an entire shoe, or simply a sole. This is carried out by an algorithm or code, where a separate algorithm or code is used for each type of shoe or sole designed. The completed component is sent from the 2D design engine 902 to the projection engine 904, and the projection engine 904 also receives the 3D UV map of the custom object 708 from the UV Mapping System 82. The projection engine 904 then morphs all the elements created on the flat plane UV map to the custom 3D UV map using the corresponding UVW co-ordinates. In this way, the footwear article is projected from the flat plane UV map to fit the custom object, creating a 3D mesh of custom-fitted footwear.

An example of how a flat plane UV map is translated to a 3D UV mapped object is illustrated in FIG. 23A. It should be noted that this figure only shows how the 2D UV map translates, and not how any substance added to the 2D map translates. As illustrated, when translating the 2D UV flat map to the 3D UV mapped object, the resultant object contains only one seam and one edge. This is a reduction compared to the prior art methods, where objects are split into separate components, substance is added to each component separately, and then the components are fitted together. Additionally, the uniform grid obtained using the method of the present embodiment ensures the geometry of the created footwear is accurate and consistent. FIG. 23B shows an example of a sole created on a flat plane UV map, which is then wrapped around a custom 3D object, a last.

Once the features have been translated onto the 3D object by the projection engine 904, the 3D mesh object is output to the mesh exporter 906, which transforms the mesh into a format suitable for 3D printing, and outputs the file for 3D printing.

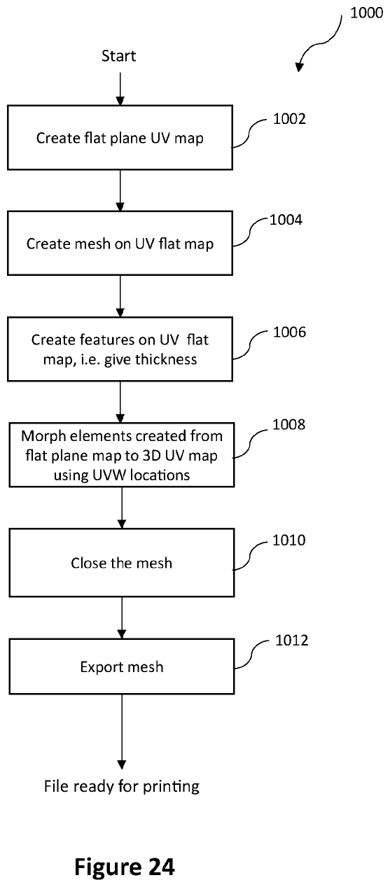

The process 1000 carried out by the footwear creator 84 is provided by the flowchart in FIG. 24. A flat plane UV map is created at Step 1002, and a mesh is added to the flat plane UV map at Step 1004. At Step 1006, substance is added to the flat plane UV map, which involves building thickness in the W direction. The elements created on the flat plane UV map are then morphed to the 3D UV mapped adjusted object (provided by the UV Mapping System 82) at Step 1008, and the 3D adjusted object with the design elements is run through a voxel or implicit geometry field at Step 1010 to unify the separate parts (that is, to unify each square in the mesh into a single object). This step closes the mesh, which is important for subsequent 3D printing of the custom object, so that the 3D printer can determine what is inside and what is outside of the model. The mesh is then exported at Step 1012, to output a file containing details of the custom-fitted footwear, ready for printing.

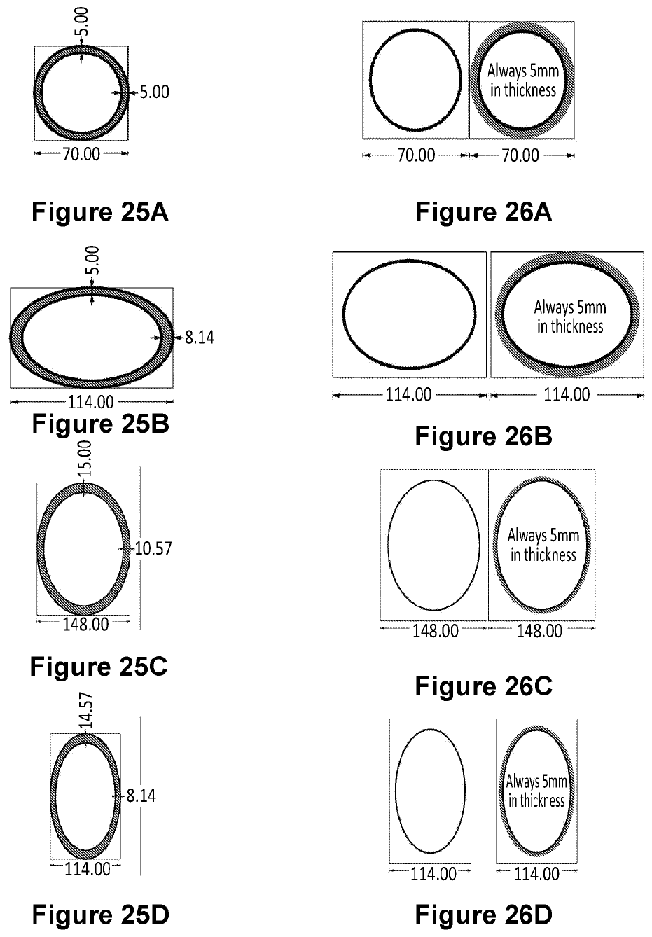

The footwear creation process 1000 according to the present embodiment has several benefits over the prior art methods discussed above. A principle of the prior art method is shown in FIG. 25A to D, which shows that when an object is created in 3D and then deformed (for example footwear is created and then deformed fit a custom scan) the footwear will have inaccurate geometry. In more detail, FIG. 25A shows an example of an object created that has a thickness of 5 mm. As illustrated in FIG. 25B to D, when the object is deformed, for example compressed, made wider, or made narrower, the thickness of the object substance is inconsistent across different parts of the object, and does not match the original design. The design will also be different across different objects, resulting in a sub-standard product. The method of the present embodiment, where an object with no substance (for example a digital last) is first deformed to create a custom object (a custom last), and then substance is created in 2D before translating to 3D, ensures consistent geometry across all custom objects. The two-step process of the present embodiment is shown in FIGS. 26A to 25D, where FIG. 26A shows an object that is created and then substance added to give it a thickness of 5 mm. FIG. 26B to D show that when the object is deformed (and so its dimensions are changed), since the substance is added post-deformation, the thickness of the substance is maintained across different objects, and is consistent within all parts of the object.

Additionally, as the method of the present embodiment first designs an article in 2D space and projects this to any object in 3D space (such as a last of foot scan) while maintaining the geometry, the same 2D article can be used for any input object. This is significantly more efficient than prior art methods, where a new custom article is created from scratch for each custom input scan. As such, the method of the present embodiment allows for rapid production of custom footwear, and significantly improves the accuracy and efficiency of footwear manufacture.

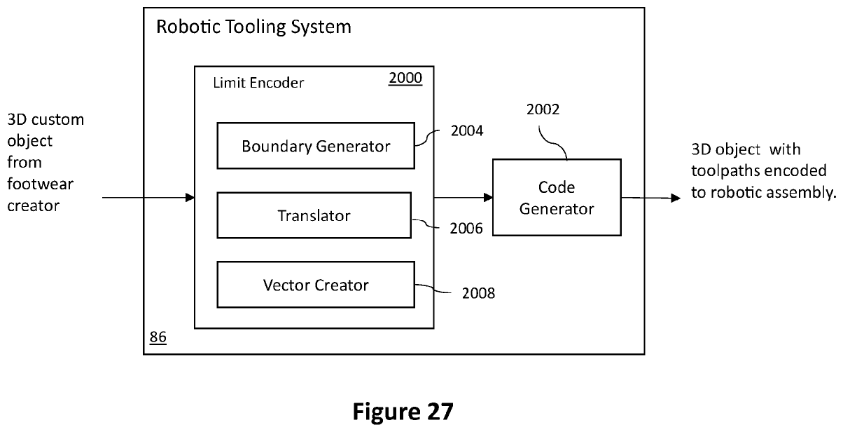

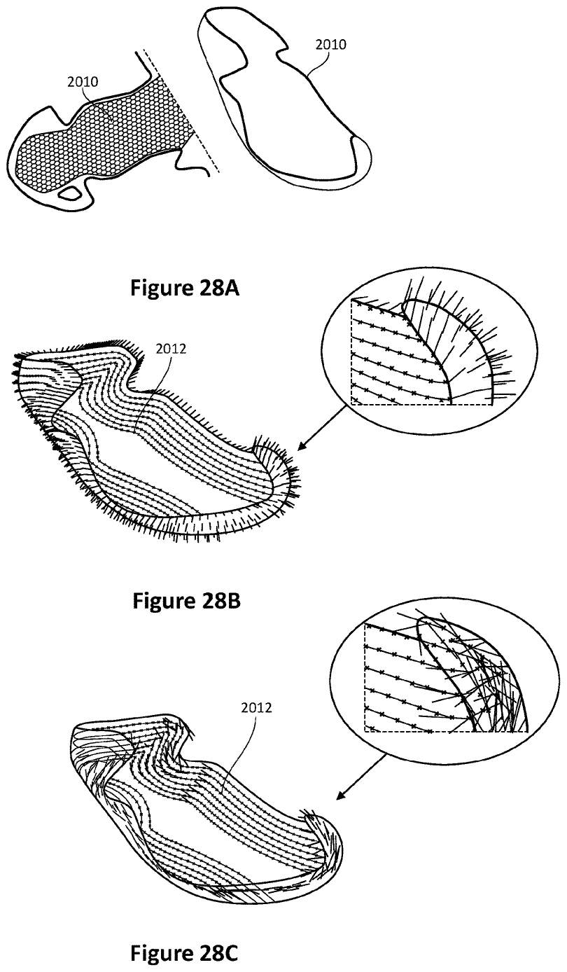

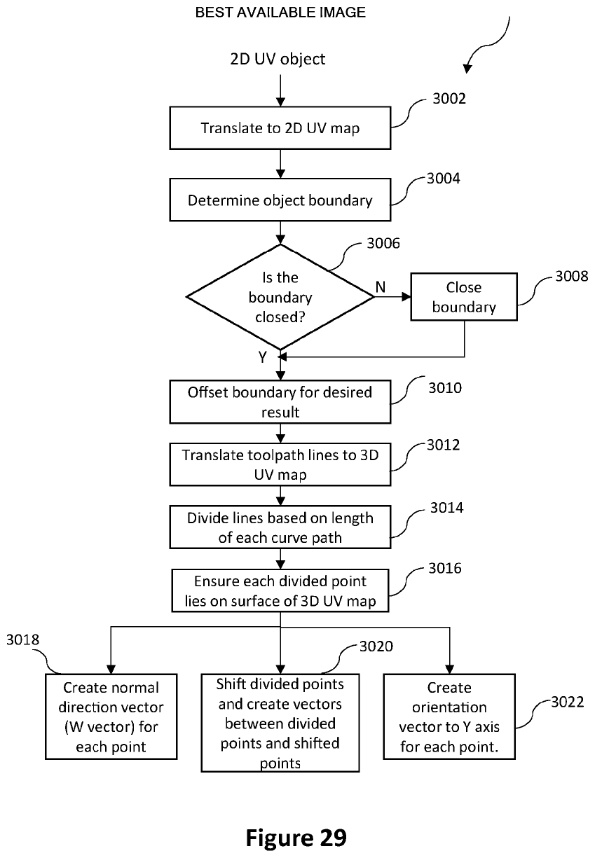

Toolpaths. As mentioned briefly and illustrated in FIG. 11, the footwear creator 84 is in communication with the robotic tooling system 86. The robotic tooling system 86 is responsible for generating instructions for controlling a robot to assemble a footwear article. More particularly, the robotic tooling system 86 generates toolpaths to guide robot arms during footwear manufacture, and the system is shown in greater detail in FIG. 27. The robotic tooling system 86 comprises a limit encoder 2000 operatively coupled to a code generator 2002, where the limit encoder 2000 includes a boundary generator 2004, a translator 2006, and a vector creator 2008. In use, the 3D mapped custom object produced by the footwear creator 84 is input to the translator 2006, which first translates the 3D object back to a 2D UV map. Using the 2D UV map, the boundary generator 2004 detects the boundary 2010 of the object, ensures it is fully closed, and offsets the boundary 2010 to create multiple toolpaths 2012, before the translator 2006 translates the boundary 2010 and offset lines 2012 back to the 3D UV mapped object, as illustrated in FIG. 28A. Only the boundary line 2010 is shown in FIG. 28A, with the offset lines excluded for the reader's clarity. The vector creator 2008 then creates a series of points along the toolpaths 2012 and creates three orientation vectors for each point: a W vector (aligned in the normal direction, example shown in FIG. 28B), a V vector (aligned in the direction of travel, example shown in FIG. 28C) and a U vector (aligned towards the centre of the toolpath to limit rotation). The normal direction is important as it defines a direction of movement of the tool head to engage the object with which the toolhead is interacting. The three vectors act together to limit the movement of the robot head to the toolpath 2012, ensuring that the that the robot arm does not lift or rotate from the toolpath 2012, and continues along the generated toolpath 2014 during operation. It is also possible to assign weights to these vectors which can be used to direct glue flow and the speed of the robot tool head movement along the toolpath 2012, but this is not discussed in detail here.

Once the limits are generated, the vectors are output to the code generator 2002, which changes the vectors into G-code (a widely used computer numerical control (CNC) programming language). The code generator 2002 uses a refactoring script, to change the vectors into G-code, resulting in a set of commands that can be understood by a robot. In the G-code, the U, V, and W vectors become X, Y, and Z vectors respectively. Therefore, the output of the robotic tooling system 86 is the 3D object with encoded toolpaths 2012, which is output to the robotic assembly 78.

During robotic assembly, the robotic tool head will move along a singular toolpath 2012 in a series of steps, additively depositing glue as it moves. The X, Y, and Z vectors created limit the robot tool head movement ensuring it moves efficiently and accurately along the toolpath 2012. Once the first toolpath 2012 has been completed, the robot jumps to the next toolpath, and repeats the process until glue has been deposited on all encoded toolpaths. FIG. 28C shows a sole with a plurality of toolpaths 2012 which each need to be iteratively traversed by the tool head to effect gluing of the sole to the shoe.

The process 3000 carried out by the limit encoder 2000 is shown in more detail in the flowchart in FIG. 29. Once the 2D object is received, at Step 3002, the object is translated back to a 2D UV map, and then the limit encoder finds the boundary of the object at Step 3004. At Step 3006, the system determines if the boundary is closed. If the boundary is not closed, the boundary is closed at Step 3008, and then the boundary is offset multiple times to the locations on the 2D UV object where glue should be deposited by the robot arms at Step 3010. Multiple offset lines are required as multiple glue deposition lines are needed to manufacture the items of footwear (also shown in FIG. 28C corresponding to the plurality of toolpaths 2012). If, at Step 3006, the boundary is found to be closed, the system proceeds directly to Step 3010 and offsets the boundary to the desired glue deposition locations. This size of offset is an input to the limit encoder and can be changed depending on the designed object.

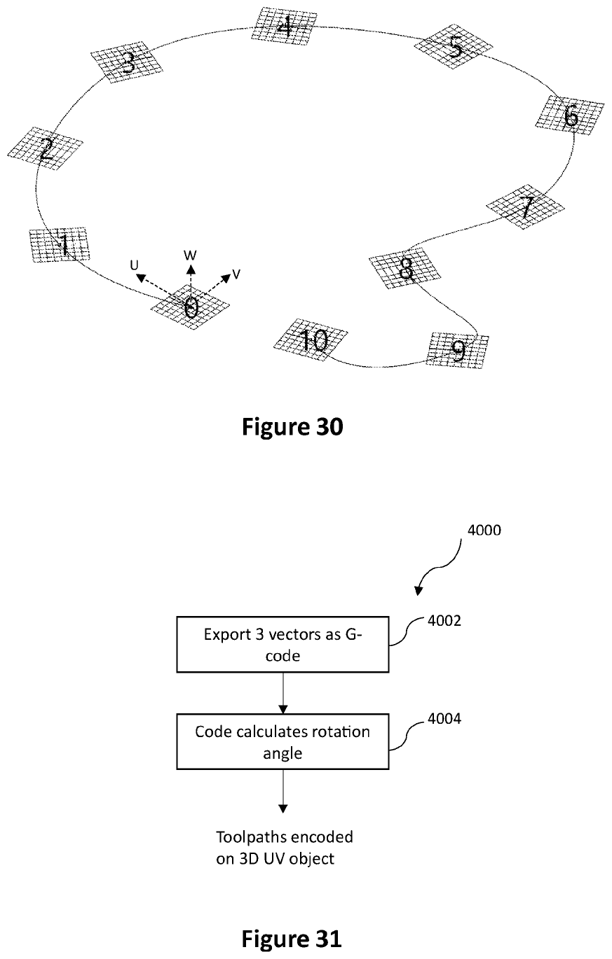

The offset boundary lines are translated to the 3D UV map at Step 3012, and each of these lines is then divided into a series of points at Step 3014, where the points act as steps for the robot tool head. The lines can be divided using two methods: based on the length of each curve path (for example the boundary curve is divided into 20 sections separated by points), or points can be created at a set distance apart from each other, for example every 5 mm. The number of points used to divide the curve is changeable, and again is an input to the limit encoder. A higher number of points increases the accuracy of the toolpath, and enough points are needed so that the toolpath line is smooth to ensure that the robot head does not jump and remains on the surface of the object. However, the higher the number of points, the greater the processing time. At Step 3016, each divided point is checked to ensure each point lies on the surface of the UV map, and points are pulled to the surface of the UV map if required. At Step 3018, the normal is found for each of the divided points and used to create a vector in the normal direction: the W vector. The W vector is used to align the robot tool control point, ensuring it is always pointing at the object. At Step 3020, the set of divided points is shifted by one in the U direction, and a vector is created between the original points and the shifted points, creating a vector characterising the direction of travel for the robot arm. The final limiting vector is created at Step 3022, where an orientating vector is created to align with the V axis. The V-vector is used to ensure the robot head does not rotate during operation. An example of one translated boundary line divided using 11 points that are used to guide a robot tool head, alongside the direction of each vector, is shown in FIG. 30.

The vectors must then be converted to a set of commands that are understandable by a robot: the vectors must be converted to a native robot code and encoded on the 3D design object. The process 4000 by which the code generator 2002 does this is illustrated by the flowchart in FIG. 31. First, at Step 4002, the 3 vectors generated by the limit encoder 2000 are exported as G-code (and become X, Y, and Z vectors), and then the code calculates the rotation angle at Step 4004. Calculating the rotation angle for each point on the boundary curve 2010 and toolpaths 2012 and integrating this parameter into the native code is required so the extruder maintains the same orientation for the entire curve and is prevented from rotating around itself. The output of the code generator 2002 is a 3D object with encoded toolpaths 2012, which can be provided to the robotic assembly 78. The encoded toolpaths 2012 mean that during manufacture the robot tool head will follow the path 2012 to additively deposit glue in the desired locations. For example, in a footwear application, the shoe is dressed with a knitted upper. A 3D printed outsole contains toolpaths 2012 on which glue can be deposited, and the outsole is then pressed to the upper to create an item of footwear. Toolpaths in the future could be used to additively deposit material to create the whole custom article.

Whilst only certain features of the disclosure have been illustrated and described herein, many modifications and changes will occur to those skilled in the art. It is, therefore, to be understood that the appended claims are intended to cover all such modifications and changes as fall within the true spirit of the disclosure. It should be appreciated that any of the features illustrated or described with respect to the figures discussed above may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method of creating a three-dimensional (3D) digital last of an appendage representing a part of a human body for use in manufacturing a custom-fitted wearable article, the method comprising:
receiving a 3D mesh object representing the appendage, the mesh object comprising a plurality of vertices and edges that defines the shape and size of the appendage;
orienting the mesh object in a plurality of degrees of freedom to align the mesh object with a predetermined orientation;
determining, from the mesh object, the values of each of a set of predetermined landscaped points specific to the type of appendage, each predetermined landscape point being configured to represent a particular geometric position of the appendage and being defined with respect to a predetermined reference point in the mesh object when orientated in the predetermined orientation;
creating a set of parameters to represent the mesh object, each parameter being defined as a predetermined measurement between at least two different landscape points; and
storing the set of parameters as the 3D digital last of the appendage.

2. The method according to claim 1, wherein the orientation step comprises aligning the mesh object with a major axis of the appendage, the major axis comprising the longest axis of the appendage.

3. The method according to claim 2, wherein the orientation step comprises pitch/roll aligning the mesh object with an X-Y plane.

4. The method according to claim 3, wherein the pitch/roll aligning step comprises:
determining the major axis of the mesh object by creating a bounding bubble sphere around the mesh object;
reducing the size of the bounding bubble sphere by a predetermined percentage;
identifying any points of the mesh object which are outside the reduced size bounding bubble sphere; and
using the identified points to determine the major axis of the appendage between the identified points.

5. The method according to claim 3, wherein the pitch/roll aligning step further comprises:
creating a plane along the major axis of the appendage;
creating a 2-dimensional (2D) profile of the appendage using the intersection of the plane and the mesh object;
determining specific features of the appendage by measuring distances from vertices of a bounding box around the 2D profile to the closest point in the 2D profile, the determining step including determining an anchor point of the appendage; and
using the anchor point to specify and appendage area which should be aligned with an X-Y plane; and
aligning the mesh object with an X-Y plane comprising the anchor point.

6. The method according to claim 2, wherein the orientation step comprises yaw aligning the mesh object within an X-Y plane, with the Y-axis.

7. The method according to claim 6, wherein the yaw aligning step comprises:
Defining the anchor point as an origin point of rotation;
Translating each of the mesh object points and the centroid of the appendage from 3D locations in the mesh object to 2D locations into the X-Y plane;
Carrying out geometric calculations using the anchor point and main axis to define the centre of the appendage; and
Aligning a vector from the anchor point the centre of the appendage with the Y axis to align the mesh object with the Y-axis.

8. The method according to claim 1, 7, wherein the orientation step comprises using a plurality of different bounding algorithms to determine orientation of the mesh object and then selecting the most accurate algorithm to provide the determined orientation.

9. The method according to claim 8, wherein the plurality of bounding algorithms is selected from the group of bounding algorithms comprising Euclidean, Welzl, Bouncing Bubble, and minimal Bounding-Box algorithms.

10. The method according to claim 1, 9, wherein the receiving step further comprises receiving a User Identifier (ID) with the mesh object and the storing step comprises storing the User ID with the 3D digital last of the appendage.

11. The method according to claim 10, wherein the storing step comprises creating an anonymised data file comprising the set of landscaped points, their position in 3D space, and the set of parameters, and storing the same in the data store.

12. The method according to claim 1, further comprising using a plurality of the anonymised data files to create an averaged 3D digital last by averaging data of the anonymised data files.

13. The method according to claim 12, wherein the using step comprises filtering the anonymised data files to select a subset with specific predetermined characteristics to determine a specific digital last conforming to those characteristics.

14. The method according to claim 12, further comprising obtaining the 3D digital last and the averaged 3D digital last, calculating the difference between the landscaped points of the averaged 3D digital last and the landscaped points on the 3D digital last, using the difference to calculate a vector and morphing the averaged last to a new adjusted 3D digital last using the vector.

15. The method according to claim 1, further comprising scanning an appendage and creating a 3D mesh object representing the appendage.

16. The method according to claim 1, wherein the 3D mesh object represents a human foot or hand.

17. A system for creating a three-dimensional (3D) digital last of an appendage representing a part of a human body for use in manufacturing a custom-fitted wearable article, the system comprising:
an input processor configured to receive a three-dimensional mesh object representing the appendage, the mesh object comprising a plurality of vertices and edges that defines the shape and size of the appendage;
an object orientation engine configured to orient the mesh object in a plurality of degrees of freedom to align the mesh object with a predetermined orientation;
an object landscaper configured to determining, from the mesh object, the values of each of a set of predetermined landscaped points specific to the type of appendage, each predetermined landscape point being configured to represent a particular geometric position of the appendage and being defined with respect to a predetermined reference point in the mesh object when orientated in the predetermined orientation;
a data extractor configured to create a set of parameters to represent the mesh object, each parameter being defined as a predetermined measurement between at least two different landscape points; and
a data store configured to storing the set of parameters as the 3D digital last of the appendage.

18-59. (canceled)

60. The system according to claim 17, wherein the object orientation engine is configured to align the mesh object with a major axis of the appendage, the major axis comprising the longest axis of the appendage.

61. The system according to claim 60, wherein the object orientation engine comprises a pitch/roll aligner configured to align the mesh object with an X-Y plane.

62. The system according to claim 61, wherein to align the mesh object with the X-Y plane, the pitch/roll aligner is configured to:
determine the major axis of the mesh object by creating a bounding bubble sphere around the mesh object;
reduce the size of the bounding bubble sphere by a predetermined percentage;
identify any points of the mesh object which are outside the reduced size bounding bubble sphere; and
use the identified points to determine the major axis of the appendage between the identified points.

63. A method of creating a three-dimensional (3D) digital last of an appendage representing a part of a human body for use in manufacturing a custom-fitted wearable article, the method comprising:
receiving a 3D mesh object representing the appendage, the mesh object comprising a plurality of vertices and edges that defines the shape and size of the appendage;
dividing the mesh object using a set of predetermined landscaped points, each predetermined landscaped point being configured to divide the object at the same geometric position of the mesh object independent of the individual object;
extracting a set of parameters to represent the mesh object, each parameter being defined as a predetermined measurement between at least two different landscaped points; and
outputting the set of parameters as the 3D digital last of the appendage.
